(19) United States
(12) Patent Application Publication
(10) Pub. No.: US 2006/0100919 A1
(43) Pub. Date: May 11, 2006

(54) Employee recruiting systems and methods

(76) Inventor: Paul A Levine, San Diego, CA (US)

Correspondence Address: PITNEY HARDIN LLP, 7 TIMES SQUARE, NEW YORK, NY, 10036-7311, US

(21) Appl. No.: 10/515,707

(22) PCT Filed: May 23, 2003
(86) PCT No.: PCT/US03/16331

§ 371 Date: Nov. 7, 2005

(30) Foreign Application Priority Data
May 24, 2002 (US) 60383022

(51) Int. Cl. H04M 3/51

(52) U.S. Cl. 705/11

(57) ABSTRACT

Methods and systems for employment recruiting are provided. In one aspect, a remote call center is used to make initial contact with the candidates to obtain information regarding their placeability and urgency in changing jobs, and to provide an initial screening (107), and a local candidate specialist may then personally interview the candidate. In another aspect, compensation is set for recruiters by adjusting a base compensation based on individual and group performance. In another aspect, candidates are assigned to candidate specialists, and client employers are assigned to client specialists. In another aspect, job candidates and job openings are independently obtained so that candidates will be available immediately to fill the openings. In another aspect, in a team-oriented method of matching candidates with jobs, candidates are matched to jobs by corporation among candidate specialists and client specialists. In another aspect, candidates are matched with jobs using candidate and employer ratings.

### BACKGROUND OF THE INVENTION

The present invention relates to systems and methods for employee recruiting. Recruiting firms or employment agencies generally recruit job candidates for placement with employers with job openings. The steps for recruiting candidates are typically handled by recruiters who first obtain available jobs and then obtain matching candidates for those jobs, or in the reverse. Moreover, recruiters usually receive a commission as compensation, which is generally earned when recruiters successfully place candidates in the available jobs or at some predetermined time thereafter. This approach is problematic, since it has the net effect of encouraging recruiters to hold on to job candidates that the recruiters obtain for their own placement, thus hampering communication and sharing of information that could assist in placing candidates in jobs. This approach may also create an usually significant delay before an opening can be filled and tends to prevent effectively matching the best available candidates with the best available jobs. Further, individual recruiters may not be effective in both placing candidates and obtaining employer clients.

The methods of obtaining candidates, i.e., initially identifying and signing candidates for recruiting, have typically been with either indirect or direct marketing techniques, where indirect marketing may include placing advertisements in relevant periodicals, such as newspapers and industry publications, and where direct marketing, also know as headhunting, may include telemarketing or cold calling potential candidates in an attempt to persuade them to consider changing positions. Direct marketing is typically used in specialty areas, such as Information Technology (IT), where the demand for skilled labor exceeds the supply. Generally, telemarketing, i.e., cold calling, in the employment recruiting industry is handled by recruiters who obtain for placement job candidates and employers with respective job openings. Recruiters are also located within the areas they service for ready access to candidates and employers, thus, mailing telemarketing for recruiting a local enterprise. Likewise, telem110arketing has been handled locally because many job candidates are leery of discussing personal matters, such as their desire for changing jobs, with recruiters who may be located remotely or otherwise have no connection to the candidate's community. This sensibility is particularly strong in some cultures and locations, such as in Japan. The local nature of recruiting and the reluctance to deal with remote telemarketers has also proven problematic in some locations where, for instance, there may be a shortage of skilled recruiters that are also skilled in telemarketing.

Accordingly, it would be desirable to provide employee recruiting systems and methods that address the above disadvantages and other issues.

### SUMMARY OF THE INVENTION

This invention provides methods and systems for employment recruiting. In one aspect, this invention provides a method of obtaining job candidates, which includes obtaining information in an initial screening teleconference from respective potential job candidates. A telemarketer or telemarketers who are not also employment recruiters may preferably conduct the initial screening teleconferences. Based at least partially on information obtained in respective initial screening teleconferences, potential job candidates may be selected for a follow-up personal interview conducted by an individual that is not a telemarketer, such as an employment recruiter or a candidate specialist. Optionally, telemarketers may be located remotely from the potential job candidate, such as in another city, county, or country, and where telephone calls from potential job candidates may be forwarded to telemarketers at a remote location. Further, the information obtained as a result of the initial teleconferences may include, historical information or requirements of a potential job candidate, and whether the potential job candidate is interested in leaving a current job.

In another aspect, this invention provides a method and system for matching candidates with jobs, which includes storing candidate information obtained during an initial screening teleconference, such as historical information or requirements of a potential job candidate, and whether the potential job candidate is interested in leaving a current job, and preferably a job candidate evaluation based at least on some of the information obtained during the initial screening teleconference, on a computer readable medium. The method further includes storing job information of available jobs on a computer readable medium.

The candidates may then be assigned to employment recruiters or candidate specialists based on at least the job candidate evaluation, where the employment recruiter may then access, with the aid of a computer, candidate information and job information, and select available jobs for consideration by candidates assigned to the particular recruiter or candidate specialist.

In another aspect, this invention provides an employment recruiting organization, which includes at least one facility having a staff which includes employment recruiters or candidate specialists local to the job market, coupled by a telephone communication system having a call forwarding feature for forwarding calls to at least one remote facility having a staff which includes telemarketers that are not recruiters or candidate specialists. The local telecommunication system further providing at least one local or toll telephone number, which potential job candidates may use to contact the appropriate individuals at either the local or a remote facility. The remote facility may further provide a call identification feature that indicates to potential job candidates being called by individuals at the remote facility that the telephone call originates from the local facility by causing to be displayed a telephone number of the local facility on the potential job candidates telephone set having a caller identification feature.

In another aspect, this invention provides a method of setting compensation for individuals of a group of such individuals, such as employment recruiter, which provide employment services that includes setting a base compensation and a performance goal for a particular function or set of functions for each recruiter in the group of recruiters. The method further includes measuring an actual performance of a particular recruiter, measuring an actual performance of the group, and determining an actual compensation for the particular recruiter according to the base compensation of the particular recruiter, the actual performance of the particular recruiter, and the actual performance of the group. Optionally, the performance of the individual recruiters and the performance of the group are measured over a predetermined period of time. Moreover, performance may be measured by revenue derived from the individual and from the group, on the numbers of candidates placed by each recruiter, on how quickly job candidates are placed, on compensation of jobs in which job candidate are place, on ranking of individual employers at which job candidates are placed such that performance is higher when a candidate is placed at a higher ranking employer, etc. The actual compensation may then be derived by first adjusting the base compensation according to the group's performance, then adjusting the group-adjusted base compensation according to the actual performance of the particular recruiter, or by first adjusting according to the individual performance, then adjusting the individual-adjusted base compensation according to the performance of the group. The method of setting compensation may be applied to set a compensation for each recruiter.

In another aspect, this invention provides a method of setting compensation for individuals of a group of such individuals performing a service that contributes to the overall service being performed, such as in employment recruiting, where the group may include recruiters, telemarketers, candidate specialists, client specialists, etc., and where the performance of the group and individuals may be measured by revenue derived from the individual and from the group, on the numbers of candidates placed by each recruiter, client specialist or candidate specialist, on how quickly job candidates are placed, on compensation of jobs in which job candidate are place, on ranking of individual employers at which job candidates are placed such that performance is higher when a candidate is placed at a higher ranking employer, etc. The base compensation may also be the same for all individuals in the group, or may vary according to the position, responsibility, and/or experience of members of the group.

In another aspect, this invention provides a system for use in setting compensation for a group of recruiters or for a group of individuals performing services resulting from a contribution of one or more individuals in the group, as described above, which includes a storage medium for storing data that indicates a base compensation and a performance goal for a particular function or set of functions for each recruiter in the group of recruiters, data that indicates an actual performance of a particular recruiter or individual in the group, data that indicates an actual performance of the group, and/or data that indicates the performance goal of the group. The system further includes a processor adapted to access the storage medium and execute instructions to determine an actual compensation for the particular recruiter according to the base compensation of the particular recruiter, the actual performance of the particular recruiter, and the actual performance of the group. The system may further include an interface for inputting and displaying the data relevant to computing compensation.

In another aspect, this invention provides a method for assigning job candidates to recruiters of a group of recruiters, which includes evaluating job candidates, evaluating recruiters in the group; and assigning the job candidates to a selected one of the recruiters according to a correspondence between the job candidate's evaluation and the selected recruiter's evaluation. Optionally, job candidates may be evaluated on a scale that account for placeability, such as on experience, education, time at current company, frequency of job changes, or level at current job, or rated on a degree of urgency to find a new job. Further, recruiters may be evaluated based on their respective track records in job placement, an amount of revenue derived from their services, how quickly they are able to place job candidates, etc. The candidates may be assigned in any one of a number of ways. For instance, higher rated candidates may be assigned to higher ranked recruiters. Alternatively, candidates of a particular rating may be cyclically assigned to recruiters, such that every recruiter of a group of recruiters may get the opportunity to place highly rated candidates. Job candidates may also be assigned to recruiters that obtain the candidates and to recruiters that locate unassigned candidates. In either case, the candidate assignment may be set to terminate and the candidate may then be assigned to another one of the recruiters if the recruiter is unable to place the candidate within a given time period. Although described in the context of assigning candidates to recruiters, this method may also be applied to assign job candidates to candidate specialists.

In another aspect, this invention provides a method for assigning employers with jobs to client specialists of a group of client specialists, which includes evaluating employers, evaluating client specialists in the group; and assigning the employers to a selected one of the client specialists according to a correspondence between the employers' evaluation and the selected client specialist's evaluation. Optionally, employers may be evaluated on a scale that account for the amount of fees paid by employers to fill their respective jobs, the amount jobs associated with the particular employer out of a total number of jobs of the pool of available jobs for a predetermined time, etc. Further, client specialists may be evaluated accounting for their respective track records in job placement, an amount of revenue derived from their services, how quickly they are able to place job candidates, etc. The employers may be assigned in any one of a number of ways. For instance, higher rated employers may be assigned to higher ranked client specialists. Alternatively, employers of a particular rating may be cyclically assigned to client specialists, such that every client specialist of a group of client specialist may get the opportunity to work with highly rated employers. Employers may also be assigned to client specialists that obtain the employers. In either case, the employer assignment may be set to terminate and the employer may then be assigned to another one of the client specialists if the client specialist is unable to place a job candidate with the employer assigned thereto within a given time period.

In another aspect, this invention provides a system for assigning candidates to recruiters and/or assigning employers with client specialists, as described above, which includes a storage medium for storing data indicative of evaluations of the job candidates and/or employers, and data indicative of evaluations of the recruiters and/or client specialists. The system further includes a processor adapted to access the storage medium and for executing instructions to assign the job candidates to a respective selected one of the recruiters according to a correspondence between the job candidate's evaluation and the selected recruiter's evaluation, and/or to assign the jobs of each of the employers to the respective ones of the client specialists according to a correspondence between the employer's and client specialist's evaluations.

In another aspect, this invention provides a method of employment recruiting, which includes obtaining a pool of job candidates and obtaining a pool of available jobs from associated employers independently of each other. The pool of job candidate may be obtained by telemarketers that are not candidate specialists or by candidate specialists. Similarly, the pool of jobs may be obtained by telemarketers that are not client specialists or by client specialists that are not candidate specialists. The job candidates may then be matched with the available jobs in accordance with criteria provided by job candidates and employers. The criteria specified by candidates may include a desired position, salary, location, and urgency for a new position, and the criteria specified by employers may include a desired education, experience, time at current company, frequency of job changes, and level at the job candidates' current or previous job. The matching may be performed by a candidate specialist to whom job candidates are assigned, or by client specialists to whom employers with respective jobs are assigned. The matching process may further be accomplished in a cooperative effort between candidate specialists and client specialists.

In another aspect, this invention provides a system for use in employment recruiting where the pool of available jobs from associated employers is obtained independently of the obtaining of the pool of job candidates, as described above, which includes a storage medium for storing data identifying a pool of job candidates, data identifying a pool of available jobs from associated employers, and/or data indicative of predetermined criteria provided by job candidates and employers. The system further includes a plurality of computer implemented interfaces for input of the relevant data and the interfaces communicatively connected to the storage medium via at least one network. The system also includes a processor adapted to access the storage medium and for executing instructions to match the job candidates with the available jobs in accordance with the predetermined criteria.

In another aspect, this invention provides a method for matching job candidates with available jobs, which includes matching job candidates in a pool of job candidates to at least a particular one of available jobs in a pool of available jobs from associated employers in a cooperative effort between candidate specialists to which the job candidates are assigned The cooperative effort may include a candidate specialist suggesting to another candidate specialist to which a job candidate is assigned, particular ones of the available jobs which are believed to be suitable for the job candidate assigned to the other candidate specialist; or a plurality of candidate specialists of the group of candidate specialists to suggest to other candidate specialists of the plurality of candidate specialists to which job candidates are assigned, particular ones of the available jobs which are believed to be suitable for particular ones of the job candidates.

In another aspect, this invention provides a method for matching job candidates with available jobs, which includes matching job candidates in a pool of job candidates to at least a particular one of available jobs in a pool of available jobs from associated employers in a cooperative effort between client specialist to which the employers are assigned. The cooperative effort may include a client specialist suggesting to another client specialist to which employers are assigned, particular ones of the available job candidates which are believed to be suitable for the respective available jobs of the employers assigned to the other client specialist, or a plurality of client specialists of the group of client specialists to suggest to other client specialists of the plurality of client specialists to which employers are assigned, particular ones of the available job candidates which are believed to be suitable for particular ones of the jobs of the employers.

In another aspect, this invention provides a system for matching job candidates with available jobs, as described above, which includes a storage medium for storing data regarding a pool of job candidates and a pool of available jobs from associated employers. The system further includes respective computer-implemented interfaces for use by respective candidate specialists to which the job candidates are assigned, and respective client specialists to which the employers are assigned. The system also includes a processor adapted to access the storage medium and for executing instructions for use in matching at least a particular one of the job candidates in a pool of job candidates to at least a particular one of available jobs in a pool of available jobs from associated employers in a cooperative effort between the candidate specialists, the client specialists, and/or the candidate specialists and the client specialists.

In another aspect, this invention provides a method of matching job candidates with available jobs, which includes assigning job candidates of a pool of job candidates to a particular recruiter in a group of recruiters, evaluating the job candidate, evaluating employers with respective available jobs, and matching to the job candidates to the available jobs according to a correspondence between the job candidate's evaluation and the employer's evaluation. The job candidates may be evaluated on a scale that accounts for a degree of placeability, which includes at least one of experience, education, time at current company, frequency of job changes, and level at current job. The job candidates may also be evaluated on a scale that accounts for a degree in urgency in finding a new job. The employers may be evaluated on a scale that accounts for the amount of jobs associated with the particular employer out of a total number of jobs of the pool of available jobs, the amount of jobs associated with the particular employer out of a total number of jobs of the pool of available jobs for a predetermined time, or on the amount of revenue provided thereby for a predetermined time.

In another aspect, this invention provides a system for matching job candidates with available jobs, as described above, which includes a storage medium for storing data obtained by evaluating the job candidate and by evaluating the employers with respective available jobs. The system further includes a process adapted to access the storage medium and to execute instructions to match job candidates to available jobs according to a correspondence between the job candidate's evaluation and the employer's evaluation.

### BRIEF DESCRIPTION OF THE DRAWINGS

In the figures, like-numbered elements or steps generally correspond to one another.

FIG. 1 illustrates a method of obtaining job candidates using advertising;

FIG. 2 illustrates a method of obtaining job candidates using telemarketing or cold calling;

FIG. 2a is a flowchart of a data flow of job candidate data;

FIG. 3 illustrates a method for obtaining employers with job openings;

FIG. 3a is a flowchart of a data flow of employer data;

FIG. 4 is a schematic diagram of a telecommunication system for employment recruiting including a remote call center;

FIG. 5 is a schematic diagram of a data communication system for employment recruiting including a remote call center;

FIG. 6 illustrates a method for computing recruiter compensation;

FIG. 7a illustrates a method for assigning job candidates to candidate specialists;

FIG. 7b illustrates a method far assigning job candidates to client specialists;

FIG. 8 illustrates a method for employment recruiting where a job pool and a candidate pool are independently obtained;

FIG. 9 is a diagrammatic representation of the avenues of communication for matching candidates to jobs with a cooperative effort;

FIG. 10 illustrates a method for matching job candidates to recruiters based on job candidate and employer ratings;

FIG. 11 is flowchart of an overall recruitment process;

FIG. 12 is a flowchart of an initial candidate interview process; and

FIG. 13 is a flowchart of candidates and job opening matching process.

### DETAILED DESCRIPTION

This invention provides methods and systems for employment recruiting. Generally, the employment recruiting process includes obtaining a pool of candidates for employment recruiting, obtaining a pool of jobs, assigning job candidates to employment recruiters and employers with jobs to client service specialists, matching the candidates with available jobs, closing the placement, and issuing commissions. The candidates may be obtained by telemarketers (e.g., phone operators), which may be located at call centers (CC) remote from an employment firm, in which case telephone calls from potential job candidates targeted to a local employment recruiting firm are routed to the remote CC. Telemarketers may also screen potential candidates for employment recruiters and may further maintain relations with job candidates that are potentially placeable in the future. The screening may include evaluating potential job candidates on their placeability, such as on a G1 to G5 scale. Placeable job candidates participate in follow-up personal interviews, referred to as initial candidate interviews (ICIs), which are conducted by employment recruiters, where the recruiters determine job candidates' placeability and the urgency of placing the respective job candidate. The ICI may also include evaluating candidates on their placeability, such as on a scale with P1 to P4 and UP (unplaceable) ratings, and on their urgency, such as on an A to C scale. Prospective employers, i.e., clients, and their respective jobs may also receive an employer rating, such as on a T1 to T5 scale.

The jobs may be obtained by telemarketers that screen employers for follow-up interviews with client service specialists or may be obtained directly by client service specialists. Job candidates may be assigned to recruiters according to the quality of the job candidates and recruiters. Similarly, employers may be assigned to client service specialists according to their respective quality as well. The matching job candidates with jobs may be carried out by applying a team approach and/or a cooperative effort, where employment recruiters and client services specialists share their relative knowledge of job candidates and job offers to attain a successful match. The matching may further incorporate the placeability, the urgency, and the employer ratings as factors in performing the proper match The recruiting process may further be enhanced by incorporating the performance of the group of employment recruiters as a factor in commissions for individual recruiters. For example, the individual recruiter's commission may be increased or decreased according to the overall placements for the relevant time by the group of recruiters with respect to a predetermined placement goal.

I. Obtaining Candidates and Jobs for Employment Recruiting.

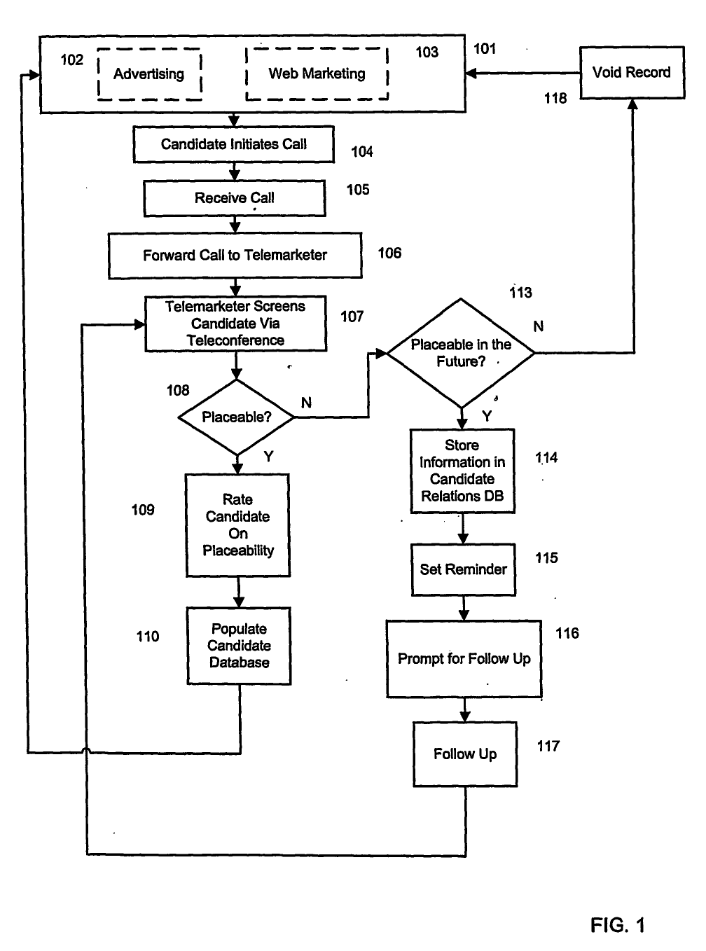

Referring to FIG. 1, a method of obtaining job candidates for employment recruiting may begin by attracting potential job candidates (101) for employment recruiting. This can be accomplished in various ways, but generally includes the necessary marketing techniques for initiating communications with potential job candidates, such as advertising (102), e.g., in periodicals such as newspapers or magazines, and web-based marketing (103), such as with an employment firm web page or via Internet advertisements, e.g., pop up advertisements, banners, etc. The advertisements preferably provide potential job candidates with contact information, such as a toll-free number or a local telephone number or numbers, which are assigned to an employment service center (ESC), described further below.

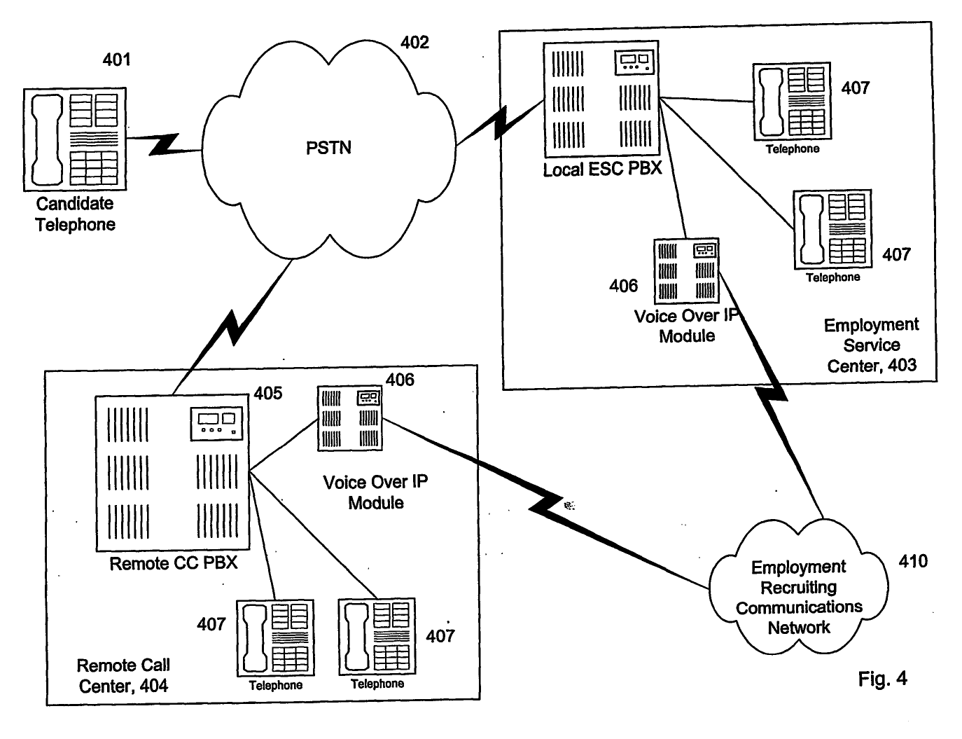

Based on the advertising and marketing, a potential job candidate initiates a phone call (104) with the telephone number or numbers provided, and telemarketers receive the call (105). The term “telemarketer” as used herein generally refers to a person whose primary function is to conduct business by telephone. At the ESC, calls from potential job candidates may be assigned to the available telemarketer (106). For, example, the next available telemarketer may take the call, or a call back may be directed to a specific telemarketer that initiated a cold call to the candidate. Optionally, the telemarketers may be located at one or more call centers (CC) that are remote from the local ESC. Remote generally denotes an area that a local ESC does not service. For instance, for an ESC that provides placement serves exclusively in a particular city, such as in Tokyo, remote includes all areas not in the particular city, such as in another city, county, prefecture or country. Additionally, for an ESC that provides national recruiting services, such as in Japan, remote includes those locations outside the country. Calls from the potential job candidates to telemarketers located at a remote CC may be received at the local ESC where they are switched to the remote CC and forwarded to the proper telemarketer (106), as discussed further in connection with FIG. 4.

Note that it is often desirable for the candidates to believe they are speaking to a local telemarketer or a recruiter or other person involved in the recruiting process. For example, many people believe it is impersonal to speak with someone who is located remotely when conducting personal business such as changing jobs. They prefer to deal with someone who they believe is part of the local community. The use of local numbers that are automatically routed to remote call centers can achieve this goal, while also allowing the call center to be located in a low cost area or other area where call center facilities and personnel are readily available. Moreover, phone calls from the telemarketers or other persons in the recruiting process who are located remotely from the candidates may be handled such that they appear to originate locally, e.g., as could be detected by the candidate using a caller identification device.

Once initial contact with job candidates is made, the telemarketers may participate in initial screening teleconferences with the potential job candidates (107) to determine whether they are eligible for a follow-up personal interview to be conducted by individuals other than the telemarketers. For example, the personal interviews may be conducted by recruiters, namely client specialists, whose function is to interact with the job candidates on a more personal level. To maintain high selection standards, it is desirable for the candidate to undergo one or more personal interviews by the recruiter before he or she is recommended for a personal interview with the employer.

The telemarketers may screen the candidates in numerous ways, e.g., by obtaining relevant historical and preference information from the candidates. Based on the information obtained, the telemarketers determine whether the candidates are placeable (108), that is, whether there is a good likelihood the candidate can be placed in a job. The relevant historic and preference information that is obtained may vary according to the particular industry and the position under consideration as expressed by the job candidate. For example, relevant information in the Information Technology (IT) field may include historic information on the candidate's education, experience, time at current company, frequency of job changes, level at current or previous job, etc., and criteria such as the desired position, salary, location, urgency for a new position, etc. Note that the criteria expressed by a candidate may include requirements, such as the need to work in a certain location, as well as preferences, such as a salary above certain level. Moreover, in some cases, information relating to age, gender, martial status, appearance, etc., may be recorded when relevant.

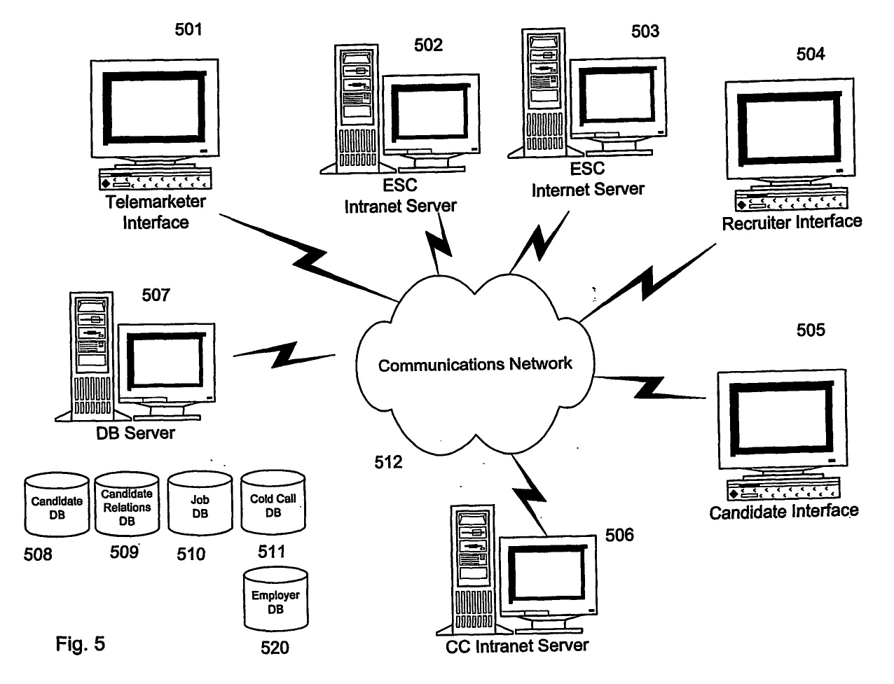

Candidates that are found to be not placeable based on historic or criteria information may be placeable in the future. For example, a candidate that is not placeable because he or she lacks the necessary education or experience for a position may be placeable in the future when he or she completes the requisite training or acquires the necessary experience. Information necessary to facilitate a follow up with a candidate determined to be possibly placeable in the future (113) may be stored (114) in a candidate relations database, and reminders may be set (115) for a follow up call to such candidates. At the appropriate future date, the telemarketers are prompted to follow up (116) with the potential job candidates. The telemarketers may be prompted to make these follow up contacts in many ways, such as with automatic pop-up messages on a computerized user interface (see FIG. 5) that are directed at an appropriate telemarketer, or with list or lists of potential job candidates to be followed up upon, which are compiled automatically, or the candidate may request a follow up call at a certain date. The reminder can be directed to an appropriate telemarketer, such as the telemarketer that made the initial contact with the candidate. If this is not possible, the reminder can be directed to the next available telemarketer. When following up on the candidates (117), the telemarketers may again screen the potential job candidates (107) to determine whether a follow up personal interview is desirable, as described above. This new screening should note any new or changed information about the candidate, such as promotions, new skills, and so forth. Records of potential job candidates that are found to be not placeable currently or in the future may be voided/erased (118). Alternatively, such records can be maintained to avoid unnecessary future contacts.

Job candidates that are found to be placeable (108) may also be evaluated by rating them on their relative placeability (109). The job candidates may be rated by the telemarketers as part of the initial screening teleconference or by others reviewing records of the initial screening teleconferences. For example, the recruiters may rate the candidates based on the information obtained by the telemarketers. The rating should incorporate at least some of the information obtained during the initial screening teleconferences, such as the potential job candidates' historical information and requirements or preferences criteria The experience and education may indicate the candidate's degree of proficiency with various software programs, programming languages, network hardware, etc. The rating scale may be expressed in a set of alphabetic or numeric characters, or a combination of both. For example, the potential job candidate rating may be expressed in the form of a G1 to G5 scale, where G1 is the highest rank. For example, a highly skilled candidate might have a G1 rating, while a moderately skilled candidate might have a G3 rating, and a relatively unskilled candidate might have a G5 rating.

Finally, records of the initial screening teleconferences with the placeable potential job candidates may be stored (110) in a job candidate database for further attention, such as for follow-up personal interviews. For example, recruiters may access the database from a location remote from the telemarketers using a computer network (see FIG. 5) to schedule the candidates for interviews. Such interviews are held between the candidate and the recruiter, typically at a recruiter's office, which is local to the candidate. The recruiters may initiate phone calls to the candidates directly for this and other purposes. The records may contain information such as the job candidate's identification, historic information, requirements and preferences criteria, and placeability rating. Information relating to a particular candidate's availability for a personal interview (e.g., days and times) may also be recorded.

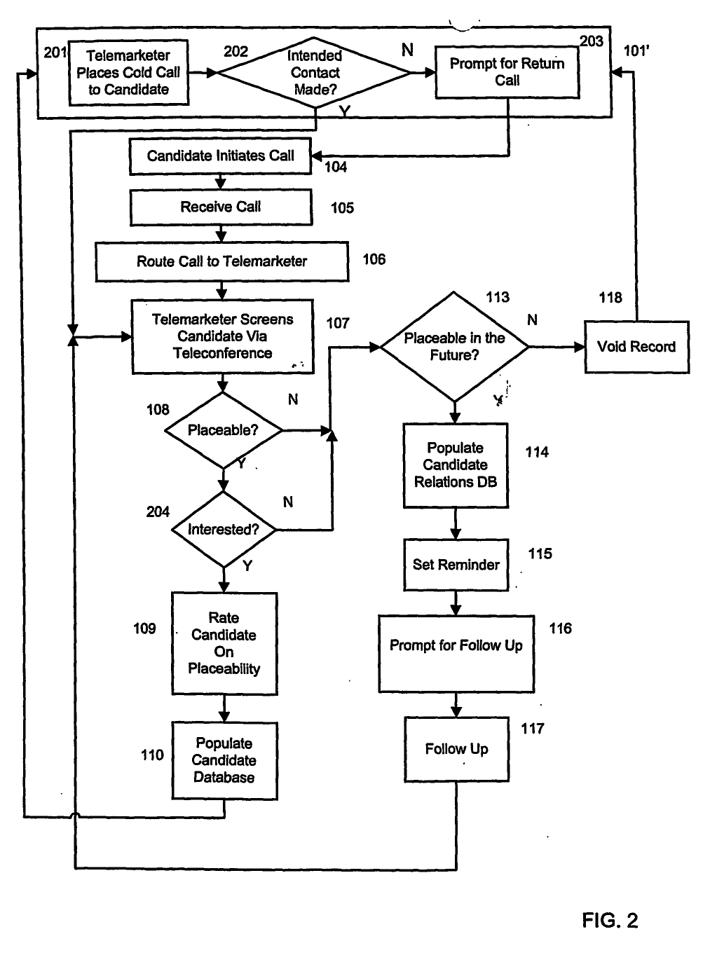

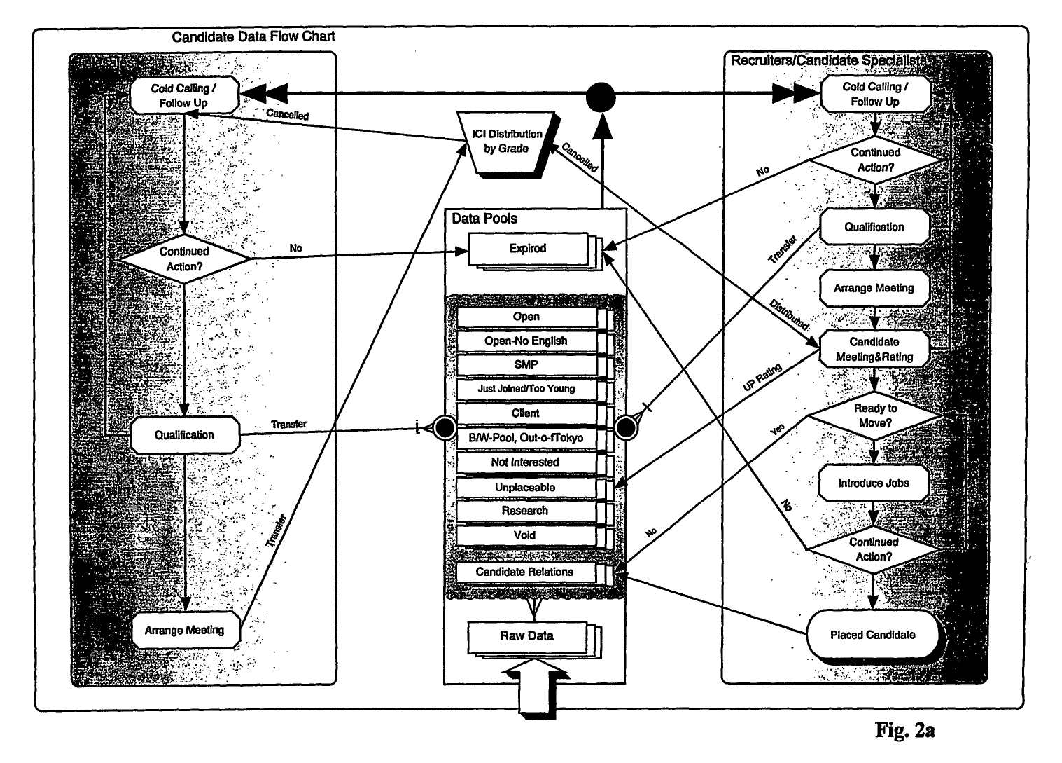

Referring to FIG. 2, the method of obtaining candidates using telemarketing or cold calling includes attracting potential job candidates (101′) by having the telemarketers initiate contact with the potential job candidates through cold calling routines. Cold calling generally refers to calling a candidate when he or she is not expecting such a call. Names and phone numbers of potential job candidates may be derived in various ways. In one approach, a company is identified which is likely to have job candidates of interest. An automatic dialer, or manual dialing, is used to dial the main telephone number of the company as well as different extensions in the company. For example, if the main number if 212-555-2000, different extensions such as 2001, 2002 and so forth can be dialed. The name of the employee may then be learned from a voicemail greeting, if available, at each extension. This dialing may be done at night when no one is expected to answer the calls. A company's web site may also be searched to obtain an employer roster, etc. Similarly, a list of graduates of specific training schools may be obtained from the schools or other sources, such as a student directory. Employees in fields that require a license or registration may also be located by searching public records of such licensees or registrants. Members of trade groups, or subscribers to trade periodicals, may also be located. The list of potential job candidates for cold calling may be stored in a cold call database. The list or lists of potential job candidates may also be derived from prompts to follow up with potential job candidates determined to be possibly placeable in the future, as described above.

Cold call routines generally include the steps necessary for telemarketers to initiate initial contact with potential job candidates. For instance, a telemarketer may cold call a potential job candidate (201) to determine if he or she is interested in changing jobs. If contact with intended potential job candidates is not made (202), he or she is prompted for a return call (203), e.g., by leaving a message for the candidate that provides a toll-free or local telephone number. When the candidate places a return call (104), it is received (105), e.g., at the ESC, and forwarded (106) to the appropriate telemarketer located at the ESC or at a remote call center (CC).

Once contact with a potential job candidate is achieved, whether as a result of the telemarketer's initial call (202) or candidate's return call (203), the telemarketer may participate in an initial screening teleconference (107) with the potential job candidate as discussed previously. Screening may be performed in numerous ways and should include obtaining relevant historic information and requirements and preferences criteria, determining whether the candidate is placeable (108), and determining whether, and to what extent, the candidate is interested in being recruited (204), e.g., leaving their current position.

Job candidates that are determined to be unplaceable or not interested may be placeable and/or interested in the future (113). For example, candidates that are not interested in being recruiting when contacted because of obligations to their current employer or perhaps a planned event that precludes changing positions at the time, may indicate a willingness to be recruited in the future. Moreover, candidates may be contract employees that are obligated to work for their current employer until a specific date. Information regarding job candidates that may be interested in future placement may also be stored in a candidate relations database (114), and reminders may be set (115) for follow up calls to the candidates. Job candidates that are found to be placeable and interested may be rated on their respective placeability (109), and a record of the initial screening teleconference may be stored (110) in a candidate database for subsequent use.

FIG. 2a is a flowchart of a data flow of job candidate data.

Regarding the “Raw Data” box, data in raw format from various sources, such as from recruiters, clients, candidates, and designated research people, flows into the system. All data is labeled for tracking purposes with tags such as the creation date and the creator's name. Telemarketers or recruiters cannot view the raw data until the data is pre-screened and associated with specific data collections or databases, such as with the candidate database, or allocated to either telemarketers or recruiters for follow up.

The telemarketing data flow is now discussed. Regarding the “Cold Calling/Follow Up” box, telemarketers are generally responsible for conducting initial screening teleconferences and setting up meetings between quality candidates and recruiters for follow-up personal interviews. Telemarketers are given an initial number of potential job candidate records for telemarketing routines, i.e., cold calling, and are allocated a set amount of records that they can independently retrieve and claim for themselves from the respective databases, such as the candidate relations database or the cold call database, for cold calling for a particular day. This number may be set to, e.g., twenty, but can be administered by management on a case-by-case basis. Telemarketers are unable to retrieve potential candidate records for those potential candidates that have already been interviewed, are already allocated to someone, or whose records are designated or raw data

Regarding the “Continued Action” box, the assignment of records that are not acted on by telemarketers that the records are assigned to within a predetermined time period, such as two months, may expire and the records may then be either reassigned to another telemarketer or in the interim be made available for other telemarketers to claim.

Regarding the “Qualification” box, eventual qualifying the candidate will result in one of the following:

a) Transfer of the candidate record to another appropriate database, i.e., from the cold call database to the candidate relations database, from the cold call database to the candidate database, etc.

b) Date and time is set for future follow up and qualification, and may include the transfer of the candidate to another telemarketer.

Regarding the “Arrange Meeting” box,

A meeting is arranged for candidates that have been qualified and the candidate records are transferred to the appropriate database for assignment to respective recruiters/candidate specialists.

Regarding the “ICI Distribution by Grade” box, the record is then assigned to a recruiter with a corresponding staff grade. Should the meeting be cancelled or rescheduled, the candidate record may be transferred back to the same telemarketer for follow up. Once the record is transferred to the recruiter, the job candidate is the responsibility of the recruiter to whom the respective record is assigned. Telemarketing sales person can track all progress for any candidate they have successfully arranged a meeting through various reports.

The recruiter data flow is now discussed. Regarding the “Cold Calling/Follow Up” box, recruiters, like telemarketers, work with an initial number of records/job candidates they are assigned.

Regarding the “Continued Action?” decision box, records assigned to recruiters must be acted on within a given period, such as seven days, else the assignment may be set to expire. Continued calling or action will prevent the assignment from expiring and being redistributed to other recruiters. Additionally, records that have seen continued action may also be set to expire, e.g., two months, after their next action date. For example, if a record is called but the person is away on business and so the next action is to call back on his return in one month on March 15, then the expiration date would be two months after that action item, or May 15. Further, future action can be limited to being set a maximum of, e.g., three months in advance, which makes all records have expiration dates within the next five months. Hence, in the above example, the next action date at most could be around May 15, which would make the expiration date then around July 15.

The two exceptions to the above expiration rules are:

1) Based on the recruiter's grade/ranking, they are allocated a number of exemptions, ranging from 0-1,000. Any record marked as exempt will not expire.

2) Once a candidate has been placed or is still in process with a client, the assignment will not expire.

All records set to expire will do so at the end of the day on the expiration date. They will be automatically designated as unassigned and may be reassigned accordingly or accessible to other recruiters for matching.

Regarding the “Qualification” box, with continued follow up by the recruiter, records may be transferred to any appropriate database or to another recruiter. Recruiters assigned particular records may qualify job candidates and once qualified, a meeting date and time may be set. If the meeting is cancelled or rescheduled, then the recruiter is required to follow up and re-qualify.

Regarding the “Candidate Meeting and Rating” box, after being interviewed candidates are given a rating (P-Rating). An unplaceable candidate's record is transferred automatically to the corresponding database, i.e., client relations database, etc.

Regarding the “Ready to Move?” decision box, the records of placeable candidates that are not ready to change their jobs when contacted may be transferred to the candidate relations database for follow up by candidate relations staff. When these candidates are ready to look at new opportunities, their record may be transferred back to the respective recruiter.

Regarding the “Introduce Jobs” box, placeable candidates ready to change their job are presented matching jobs and if interested are introduced to the employers.

The databases are now discussed. The following are the descriptions of the data variables that may be associated with particular job candidate records and that may be used to trigger or cause records to be transferred from a main database, i.e., the cold calling database, to another more appropriate database, e.g., candidate relation, etc., or may be used to trigger action by the appropriate responsible party or parties.

Open: New data that has not yet been called, called data that has not been successful, and candidates that recruiters no longer wish to work with.

Open-No English: As above but the candidate has limited or no English language skills.

SMP: Senior Management Practice. These are senior candidates specifically for executive search and will be followed up and acted on by the SMP Group.

Just Joined/Too Young: Candidates who have recently graduated so they are difficult to place as clients are unwilling to pay fees for young inexperienced staff. Also, candidates who have recently started at a company are not easily or shouldn't be placed as it is detrimental to their career to change employers quickly and/or regularly.

Client: Currently a client of the recruiting organization, which should not canvass or poach candidates from its clients or vendors.

Not interested: Candidate is not interested in changing their job or receiving new company information.

Unplaceable: Based on our client's specifications and the recruiting organization's own quality criteria, these are candidates that we will be unable to assist in their career search.

Research: The record contains no contact or old contact information so is in a pool for research staff to search out possible contact numbers to try and locate the candidates.

Void: Similar to “research”, in that the person or information is no longer valid and all other possible leads already sourced from the record. The record itself would seem to have no inherent value and sending to research would most likely redeem no results.

Candidate Relations: A pool of met, placeable candidates who are not ready to move yet because of job commitments or personal reasons. Contact by a candidate relations team member will ensure that when they are ready to move we will know and the record will be transferred back to the recruiter who met with them or as appropriate.

Raw Data:

New data inputted by research or acquired through candidate or client referrals. This is an initial pool to be able to enter the data into the system but be restricted from the view of all recruiters and telemarketing staff until ready.

B/W-Pool, Out-of-Tokyo: These are open pre-screened records of candidates/companies which are difficult to contact or likely to be difficult to find jobs for. For example they reside well out of the city area, are overseas or work in a completely different industry.

In a further aspect of the invention, throughout the lifecycle of the records, statistics are automatically created based on the action taken and results accomplished. In one approach, only one statistic is allowed for each type of action for each record. Regarding the “Arrange Meeting” box under “Recruiter/Candidate Specialists” in FIG. 2a, initial calling statistics created by consultants and telemarketing staff are:

1) CCP Statistic (Cold Call Presentation)—The date, candidate and callers details are stored when the candidate is informed of the recruiting organization and asked to come in for a meeting.

2) ICI Statistic (Initial Candidate Interface)—Again, the date, candidate and callers details are stored if a meeting date and time is set with the candidate.

Regarding the “Introduce Jobs” box, at every stage of the process with a client as the status changes, a statistic is created to store the type, candidate, recruiter and, if necessary, the Client Services and Telemarketer caller details associated with the candidate. For example, if the ICI was arranged by a telemarketer and the job suggestion came from a client services representative then all of these details would be tagged to each of the statistics created for the candidate with this client.

Client Status and Statistics May Include:

Action—An initial entry choice for a recruiter to remind them to action a candidate to a client. These entries also include all items from client services staff for possible job matches to their candidates as well as any item that had been labeled an automated action item (see Resume).

Resume—As soon as the resume is sent to the client for review the candidate's status is updated and this statistic is created. For any resume sent to a client that exceeds, e.g., twenty-one days the status will be automatically changed to an “Action” item that cannot be placed in “Resume” sent status again. This candidate for this client must either become an “Introduction” meeting or be “Process Terminated”.

Introduction—Created when the first meeting between the candidate and client is confirmed.

2nd Meeting through 5th+ Meeting—Created when the 2nd, 3rd, 4th and 5th+ meetings between the candidate and client are confirmed.

Verbal Offer—Verbal acknowledgment to the candidate from the company that they would like to extend them an offer to join. This may or may not actually occur.

Paper Offer—An actual physical paper offer is received by the candidate to join the company.

Signed/Resignation—The candidate signs the paper offer and is now in a resignation process with their current employer.

Started: Not Paid—The candidate has successfully resigned from their previous employer and joined the new client company, although we have yet to receive any payment for services rendered. At this stage or sometimes earlier the invoice is prepared and sent to

Started: RO Paid—The candidate is still with the client company and the recruiting organization (RO) has been paid for all services.

Started: C Paid

The final step is that the recruiter/candidate specialist (C) is paid for placing the candidate with the client.

Process Terminated—For either reasons given by the client or candidate, the interview process is terminated.

In a further aspect of the invention, data generated from all the statistics and client status entries enables a number of reports to be produced both on the candidate and client side. Totals and percentages can be displayed for all reports as required on either a weekly or yearly totals basis. This can be achieved for individuals, for a team, the entire company, a client, a group of companies or all companies. The reports may include the following.

Recruiter Reports:
Individual Status Report—A status report is automatically generated for each candidate and company introduced to. This report includes all records from “Action” through to “Started: Not Paid”. Records with a status of “Started: Me Paid” or “Process Terminated” are automatically omitted from this report. As all statistics are stored, for each section of the status report detailed numbers can be included for each entry, e.g., the number of days since the resume was sent and the number of days the entry has been at that particular status. For example an entry in 3rd Meeting for a candidate may have had the resume sent thirty days ago and has been at the 3rd Meeting stage for five days.
Individual Statistics Report—A statistics report shows the totals of each of the statistics for the current week, for example, the total number of CCP's, ICI's, Resumes, Introductions, Offers and Placements. A percentage is also displayed for the ratio of Resumes to Introductions. These reports can also be produced for any team or for the company as a whole. Additionally the report can be for a Telesales caller, all callers, a client services specialist or specialists.

Client Reports:

As recruiters are creating status entries and statistics for clients based on their candidate actions, reports can be also produced for the client side.
Client Status Report—The same format as any other status report but is specific to the client and includes all related recruiter entries.
Client Statistics Report—Again the same format as any other statistic report but is specific to the client and includes all statistics from all recruiters for any time period.

Statistical Conversions:

Finally, conversion rates and times can be calculated based on any criteria as each statistic is individually stored and dated. Examples include: Time line for a candidate between each step: days from resume to intro, days from intro to offer, days from ICI to placement, etc. Another example: Time line for a recruiter or group or all recruiters for any statistic or client between each step. Another example: Conversion percentages for any individual, group or client for any statistic: % of resumes to introductions, % of 1st to 2nd Meeting, % of Offer to Placements, % of ICI to Placement, etc.

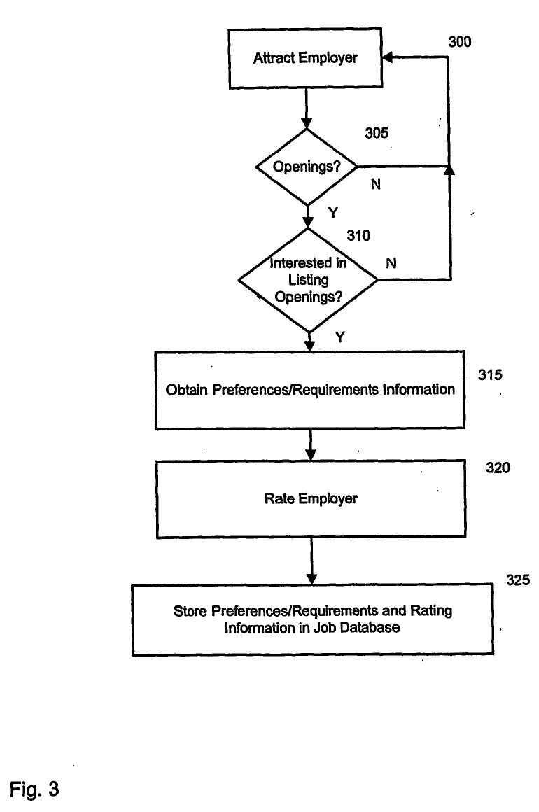

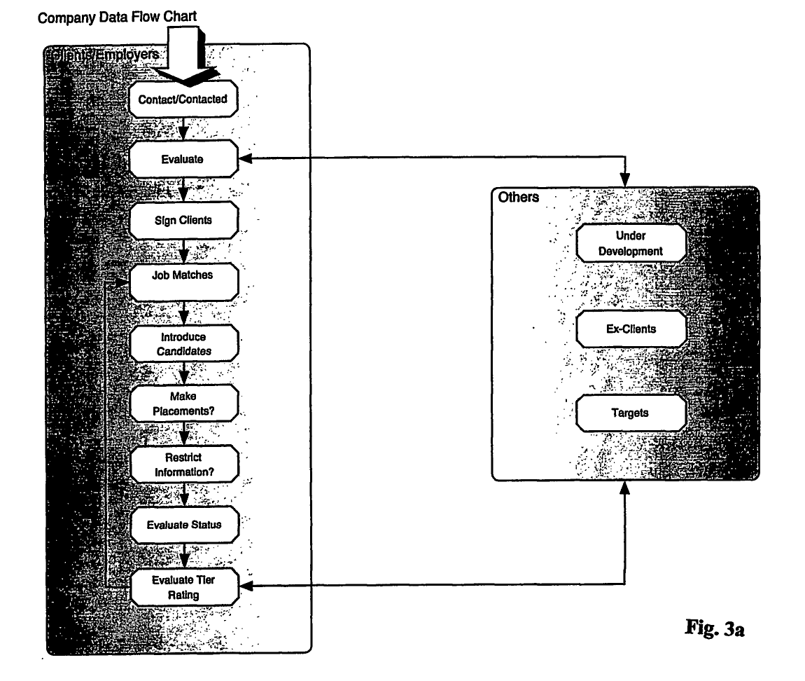

Referring to FIG. 3, a method of obtaining employers with job openings may begin by attracting employers with jobs (300), e.g., using the necessary marketing technique for initiating communications with the employers, such as by advertising or by telemarketing techniques, similar to the approaches used for obtaining the job candidates. A telemarketer may initiate contact with an employer, and participate in an initial screening teleconference. If the employer is sufficiently interested, and the telemarketer believes it is appropriate, a follow up meeting (e.g., via phone or personally) may be scheduled between the employer and a person such as a client specialist. The client specialist is primarily concerned with interacting with client employers to determine their employment needs and ensure they receive good service. The client specialist is generally not a telemarketer, and can also be distinguished from a candidate specialist, who is primarily concerned with interacting with and servicing job candidates. Moreover, note that a recruiting process may occur where the job candidates are clients since they pay a fee to be matched with a job. In this case, a distinction may be made between a candidate client specialist and an employer client specialist. Moreover, the term “recruiter” may encompass both the candidate specialist and the client specialist(s).

The screening performed by the telemarketer may include determining whether the employer possesses available job openings (305), and if so, how many and what type, and whether the employer is interested in listing their job openings (310) with the recruiting/employment firm. If the employer possesses available jobs and is interested, an employer meeting may be arranged between the employer and the client specialist to gather the relevant information for the particular jobs (315) and sign the employer to a contract that specifies the fees to be paid. This information may also be obtained by the telemarketer. Relevant information may vary according to the particular industry and the position being listed, and may include historical information, and requirements and preferences criteria The criteria for a job opening may include both required elements that the candidate must meet, and preferred elements that the candidate preferably meets. These criteria may be complements of the requirements and preferences criteria expressed by the candidates.

The employer may be evaluated/rated (320) on its overall value to the recruiting firm based on factors such as the potential revenue that may be derived from the particular employer, the quantity of jobs listed with the firm in the past, and current listings in relation to the total jobs listed with the firm over a desired time frame, e.g., past six months, etc. The rating or tier may be expressed in a set of alphabetic or numeric characters, or a combination of both, e.g., in the form of a T1 to T5 scale, where T1 is a greater rank than T2, T2 is greater than T3, etc. See the related discussion on the T scale further below.

Records of the jobs may be stored in a job-opening database (325). The information stored in the records may include the employers' requirements and preferences criteria for the particular job opening, the employers' rating, and so forth

FIG. 3a is a flowchart of a data flow of employer data.

Regarding the “evaluate” box, records, i.e., information, on companies and their respective job openings are preferably all stored in single database with data fields or variables that indicate their status. The status may then be used for providing or limiting access to the particular employer records. This makes it very effective in changing the access properties of company records seamlessly and instantly by simply altering a few fields rather than having to manually move them to separate files. This would simplify changes because for example a client/employer has been purchased or merged with a competitor and is thus no longer be a client. In this instance, the status may be changed to ex-client or target, and this would prevent recruiters from viewing any job openings and perhaps accidentally calling or sending a candidate resume. A client services department or staff may maintain all information regarding companies whether they are clients, ex-clients, targets or are under development. Once a client is signed, recruiters generally have access to view records associated with a particular client and may introduce candidates to the clients either directly or through the client services group.

Regarding the “Job Matches” box, in addition to candidate specialists matching candidates to job openings this is also a major function of client specialists. They have the ability to search all candidate information and resumes and automatically notify candidate specialists of a match with their candidate to a specific job opening. The suggestions need to be followed up by the client specialists that suggested the match. If the candidate specialist takes no action on the suggestion in, e.g., twenty-one days, however, then the suggestion is removed.

Regarding the “Restrict Information?” box, client services has the ability to restrict access to particular information in the client records, such as a list of contact names with the client, the job openings listed for a particular client, or both. Once restricted, only specific personnel, such as Team Leaders, can freely view the information.

Regarding the “Evaluate Status and Evaluate Tier Rating” boxes, whether making placements in the client or not, all companies are regularly evaluated and their status altered accordingly. Each client record has available scans of maps, contracts, and offer letters. Each also contains as much company information as possible, such as HQ PDF files, company history, products, partners, corporate culture, staff numbers, revenue figures, client services comments, candidate specialist comments and other related information such as each contact person's profile, where possible. Candidate specialists may also have access to resumes of all candidates placed with a particular client in order to become familiar with a typical candidate profile for the client.

Employment Recruiting Telecommunication System Description

Referring to FIG. 4, an embodiment of a telecommunications system for use in employment recruiting is shown. Here, telephone calls that are placed by a candidate to a local phone number may be forwarded to a remote call center so that the candidate is unaware that he is speaking with a remotely located person. In one possible embodiment, the system includes a local employment service center (ESC) facility (403) and a remote CC private branch exchange (PBX) facility (404), each with an optional voice over IP (VOIP) module (406), and a plurality of telephone terminals (407). The PBX may use a manual switchboard, or may include a private automatic branch exchange (PABX), which may or may not use a switchboard. The ESC 403 may be an office where the client specialists and candidate specialists work and conduct interviews and meetings with candidates and employers. The components at each location may be considered part of a telecommunications apparatus.

Also, a communications network, such as a public switched telephone network (PSTN), a wide area network (WAN), or a local area network (LAN), or a combination thereof, may be used. In a preferred embodiment, the communication network includes a telephone communication system such as a public switched telephone network (PSTN) (402), and an employment recruiting communications network or intranet (410), such as virtual private network (VPN), WAN, or LAN, which is private to the recruiting organization. The network 410 may also be considered part of a telephone communication system, e.g., when used with VOIP. Alternatively, or additionally, the employment recruiting communications network 410 may be implemented using the PSTN 302. The system may also include at least one automatic call distributor (ACD) (not shown) located at either the local BSC, a remote CC, or both, for distributing calls to individuals (e.g., telemarketers, candidate specialists, and client specialists) at their respective locations. Appropriate media for carrying signals between the centers 403 and 404 may be used, such as copper wire, optical fiber, and/or wireless communications equipment.

The telecommunication system generally enables callers to dial into and out of a local ESC and at least one remote CC. The anticipated phone traffic includes incoming calls originating from outside parties (e.g., job candidates and employers) to individuals at the ESC or at the remote CC, outgoing calls between individuals at the ESC and a remote CC, and outgoing calls originating from individuals at either the ESC or a remote CC to outside parties. An incoming call originating from an outside party may initially be switched at the PSTN (402) to arrive at the ESC (403), where the call may be directed to the appropriate party according to the telephone number dialed. For example, if the number dialed is assigned to an individual at the ESC, the ESC PBX (408) may forward the incoming call to the telephone terminal (407) of the desired party at the ESC. If, however, the number dialed is assigned to the remote CC or individuals at the remote CC (404), the ESC PBX (408) routes the outside party's incoming call to a remote CC PBX (405), preferably through a VPN, where the call is finally forwarded to the telephone terminal (407) of the desired party at the remote CC.

Outgoing calls from individuals at the ESC (403) to individuals at a remote CC (404) are routed at the ESC PBX (408), through the PSIN (402), preferably through a VPN, to a remote CC PBX (405), where the call is forwarded to the telephone terminal (407) of the desired party at the remote CC. Calls originating from individuals at a remote CC (404) to parties at the ESC (403) are handled in the reverse order. Optionally, calls between individuals at a remote CC and the ESC may be handled by VOIP. Outgoing calls from parties located at either the ESC (403) or a remote CC (404) may be routed at the ESC PBX (403) and a remote CC PBX (404), respectively, though the PSTN (402), to the desired outside party.

The system may be advantageously configured such that the job candidates believe they are speaking locally with the telemarketer or a recruiter or other person involved in the recruiting process. In particular, when a telemarketer at the remote call center 404 wishes to call the job candidate 401, a call is first made to the local ESC 403, where an operator transfers the call to the candidates phone number. In this manner, the caller identification information received by the candidate designates the phone number and/or name of the local ESC 403 instead of the remote CC 404. A caller identification feature offered by a PSTN may be used, for instance, as discussed in U.S. Pat. No. 4,582,956.

Referring to FIG. 5, an embodiment of a data communications system for use in employment recruiting may include a number of interfaces, such as personal computer workstations, including at least one telemarketer interface (501), at least one employment recruiter interface (504), which may include, e.g., a candidate specialist or a client specialist interface, at least one candidate interface (505), and at least one server (507), where the interfaces and server are interconnected over a communications network (512). The communications network may be, but is not limited to a WAN, a LAN, the Internet, or a combination thereof. Optionally, the data communication system may use a number of servers, such as a database server (507), an Intranet server (502) and an Internet server or servers (503). Optionally, a remote CC may maintain a separate intranet server (506). The database server may further comprise a processor such as a CPU, data storage means (computer-readable media) such as a hard drive, optical drive, disk drive, tape drive, or a combination thereof, and at least a candidate database (508) and a job database (510). Preferably, the database server may also contain a candidate relations database (508) and a cold call database (511). These databases are used generally for storing the information regarding the job candidates, clients/employers and jobs. The databases may also store information regarding recruiter compensation, group and individual performance goals and actual performance, etc. Database management software may be used to manage the data, The databases are formed by organizing the storage of data on the computer-readable media

Moreover, the computer workstations may use software for carrying out desired functions. For example, software may be used for running applications that assist in the recruiting process by providing pop-up screen, scripts and other tools for tracking and managing data related to the candidates, employers, and job openings. The software comprises instructions that are executed by the processor of a computer workstation or server to carry out one or more applications. The applications may provide an on-screen graphical user interface, voice command user interface, etc., to assist the users in their tasks. For example, when a call is received from a candidate at the telemarketer interface (501) or recruiter interface (504), software may be used that recognizes the caller via the phone number, and accesses information pertaining to the candidate's record for immediate display on-screen.

The telemarketer interfaces (501) provide a means for telemarketers to enter and access information located in the cold call database (511), candidate relations database (509), and candidate database (508), and may also provide access to email the intranet or intranets, and the Internet. Similarly, the employment recruiters may use the employment recruiter interface (504) to access the candidate database (508), candidate relations database (509), job opening databases (510), employer database (520), which includes information regarding the employers, as well as email, the intranet or intranets, and the Internet.

The candidate interface (505) may be any device or system that allow a candidate to retrieve information regarding recruiting services, and to communicate with personnel in the recruiting organization, such as a personal computer with Internet access, cell phone, including web-enabled cell phones, personal digital assistant (PDA), or any other suitable communication means. Note that an Interactive Voice Response (“IVR”) system (not shown) may also be used to enable the candidate to retrieve information and/or communicate with the telemarketers or recruiters. For example, the candidate may be able to confirm the time, date and location of an upcoming interview using an IVR system.

It should be understood to those skilled in the art that the systems depicted in FIG. 4 and FIG. 5 are two examples of many possible system arrangements that may be employed to carry out the invention and thus the systems depicted shall be viewed as merely illustrative.

II. Computing Compensation for Recruiters and Telemarketers

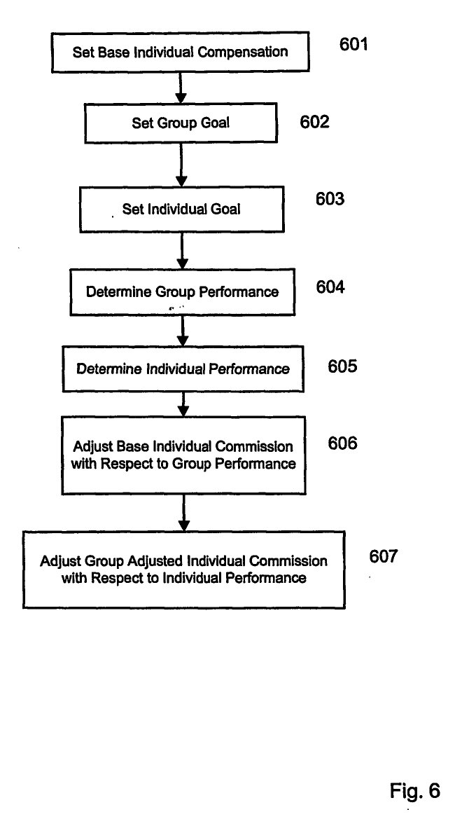

Referring to FIG. 6, a process is shown for computing compensation, such as a commission or a bonus, for an individual of a group performing substantially the same function or functions, such as employment recruiters.

Generally, the recruiting organization receives fees from the employers by obtaining candidates for their job openings. The details regarding the compensation/commission the employers will pay to the recruiting organization can be set in various ways. For example, the employers may pay a portion of a hired candidate's year's salary to the recruiting organization for each job that is filled. The payment may be conditioned on the employee successfully completing a trial period, such as three months. The employer may pay based on the number of jobs filled, and/or the level of the jobs that are filled. The employer may also pay a flat monthly or other periodic fee, where the recruiting organization fills as many jobs as it can each month for the employer. In some cases, the candidate may pay a fee to be matched with a job opening.

However, once the organization receives the fees, it is important to compensate the personnel of the organization. The compensation should award the particular individual who is primarily responsible for placing a candidate, while also encouraging teamwork and sharing of information within the recruiting organization. Moreover, these goals are also achieved when candidate specialists, who work primarily with job candidates, and client specialists, who work primarily with employers, are used.

The process may begin by setting a base individual compensation (601) for a relevant time period, e.g., a month, quarter, or year. This compensation may be arbitrarily set or derived from statistical data, such as the recruiting organization's estimated or actual revenue for the predetermined time. Group and/or individual goals may also be set (602)(603). The group may include only personnel who are performing a common function or functions, or personnel who perform different functions. For example, the group may include only candidate specialists, or only client specialists, or both types of specialists may be included. The goals may be described in terms of revenue or based on some other relevant measure, e.g., in employment recruiting context, relevant units may be the number of candidates placed for the particular time period, how quickly the candidates were placed, and even the particular employer at which they were placed. In this way, placements to certain preferred employers can be rewarded more highly. The goals may be arbitrarily set or based on past performance data of the group or of the individual, e.g., the group's or individual's revenue for a particular quarter. The individual goal may be equal for all individuals, or set to reflect the characteristics of certain individual, e.g., goals for relatively inexperienced individuals may be set lower than for others to reflect the inexperience. Similarly, the individual goal may be equal for a subset of the individuals of the group, e.g., based on experience. For example, all senior candidate specialists may have the same goal, and all junior candidate specialists may have the same goal.

The actual performance of the group (604) and of the individuals (605) is determined, and the compensation for an individual is derived by adjusting the base individual compensation to reflect the group's actual performance (606) and to reflect the individual's actual performance (607) for the relevant period. The individual compensation may be set to obtain a desired response from the individual or group. For instance, compensation may be set to promote superior group and individual performance by adjusting the base individual compensation upwards in proportion to the degree of superior performance by the group and by individual employees. Similarly, inferior performance can be deterred by adjusting the base individual compensation downwards to account for inferior performance by the group and/or the individual employee.

For example, assume a base individual compensation of $10,000, a group revenue goal of $100,000 and an individual revenue goal of $20,000. Additionally, assume the group totaled $125,000 in actual revenue and an individual totaled $30,000, that is, the group has exceeded its goal by 25% and the individual by 50%. The company may reward the group's and the individual's superior performance by adjusting the individual's. basic compensation of $10,000 up by 25% based on the group's actual performance, then adjusting the result thereof upwards by 50% for the individual's own performance. Thus, this individual's compensation is ((10,000+25%)+50%)=$12,500+50%=$18,750. Alternatively, the adjustments may be applied separately to the individual's basic compensation (i.e., 10,000+2,500+5,000=$17,500).

The individual's compensation may also be reduced proportionately if either the group and/or the individual's perform below their respective goals. Assuming, in the example above, the individual's performance for the quarter yielded $10,000, that individual's compensation is ((10,000+25%)−50%)=$6,250. Similarly, if the group's placements for the quarter yielded $75,000, the individual's compensation is ($10,000−25%)+50%=$11,250.

Moreover, the compensation may be adjusted on factors other than revenue earned. For example, for individuals providing employment recruiting services, the actual performance of the particular individual and/or group may be, measured based on a number of job candidates placed in jobs, how quickly job candidates are placed and/or the compensation of jobs in which the job candidates are placed. In a further variation, the actual performance of the particular individual is measured based on a ranking of employers at which the job candidates are placed such that performance is determined to be higher when a candidate is placed at a higher ranking employer. In this way, the compensation structure may encourage the individuals to provide better services for favored clients/employers.

Note that the compensation system may be administered by a personnel manager or the like associated with the recruiting organization. The manager may also be a recruiter him or herself Moreover, the manager may use a computerized interface to access databases that store information regarding the recruiters' performance and other relevant information. The recruiters' performance may be entered manually from time to time, e.g., by the recruiter or the manager or other designated person, or may be tracked automatically. A software program may be used to track the candidates that are assigned to the recruiters, and the amount of time for a placement. For example, the date a candidate is assigned to a recruited can be entered using using the program, along with the data the candidate is placed. The software can then automatically calculate the placement time, e.g., in days, and store the results for later use. Other information, such as the identity of the employer, and the revenue derived from the placement can also be stored for later use in determining compensation and performance. In this manner, various performance metrics for each recruiter can be developed over time for use in determining compensation.

For example, the personnel manager may use a computer to store data regarding the base compensation and performance goal for each recruiter, and data that indicates an actual performance of the recruiters and the group. Any database management software such as Microsoft Access may be used for managing the data that is stored on a storage medium associated with the computer. Based on the information entered into the database, the software may perform calculations, via instructions executed at a processor (e.g., at the server 507), to determine the actual compensation to be awarded. Such calculations may be run at the command of the operator, e.g., by clicking on an appropriate icon on a graphical user interface. Or, the calculations may be run automatically after each logon, or on some other periodic basis. Moreover, the software may be designed to display the results on the interface in an appropriate manner, such as by providing a list of recruiters and their performance information and compensation.

In a further approach, a bonus structure for the telemarketers may be provided. For example, four different bonus categories may be provided: Bonus One, Two, Team, and First Introductory bonus. All bonuses are paid out on a monthly basis. The base bonus for a telesales consultant is $1,250 per month. This is split evenly among the four targets and is not capped. (The more you go over the minimum target the more you are paid). The first bonus is paid out on the points achieved by the telemarketer and the team they work for. Points are given according to the internal rating system. This is based on the suitability of the candidate that was bought in for placement.

The rating is assigned the following points: P1=5, P2=4, P3=3, P4=2, UP=−1.

Bonus One: Based on individual telemarketer monthly achievement in total points hit. 40=$312.50. Additional $4.50 per point over the minimum target.

Bonus Two: Based on individual ICIs set by each telemarketer on a monthly basis. 20 ICIs=$312.50. Additional $8 per ICI over minimum target.

Team Bonus: Recognition of team achievement in total points (set by each team) on a weekly basis. Each team will have a unique target approved by Management. Each team target is based on team member's probation, hours worked and size of the team itself. As an example, at 60 points, bonus is $55 per member. Additional $9.17 per additional point to be distributed amongst members.

First Introductory Bonus: An incentive to encourage team members to bring in new high potentials candidates. Three introductions per week=$120. Note: If target is not met in any one week, the bonus will not be given. Additional $40 on every additional introduction.

Note that the dollar amounts given above are examples only.

III. Assigning Candidates to Candidate Specialists, and Assigning Employers to Client Specialists.

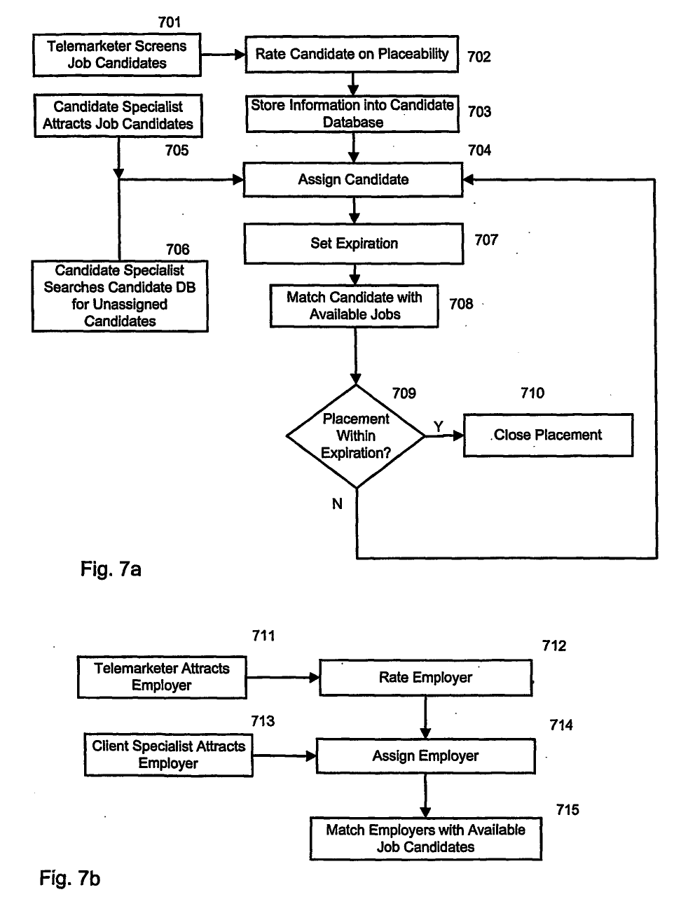

Referring to FIG. 7a, a process for assigning job candidates to candidate specialists for placement services varies depending on how the job candidates are attracted to the recruiting services. For instance, candidates attracted and screened by telemarketers (701) for a follow-up personal interview, may be assigned to candidate specialists based on respective evaluations, including quality or other characteristics, of the candidate and the candidate specialist. A goal is to assign candidates to compatible candidate specialists so they will be comfortable with one another. For example, a job candidate who is at a high level in his or her current job may be more demanding, and expect to be assigned to a highly capable candidate specialists. Alternatively, candidates of a particular rating may be assigned to recruiters in a cyclic or round robin manner (e.g., candidate #1 assigned to recruiter #1, candidate #2 assigned to recruiter #2, and so on), such that every recruiter of a group of recruiters may get the opportunity to place highly rated candidates. The cyclic assignment scheme may be limited to candidates and recruiters of the same or similar ratings.

The job candidates may be evaluated based on relevant historical information and requirements and preferences criteria, discussed previously, which may vary based on the particular industry and position under consideration, and which is gathered during the initial screening teleconferences. Preferably, job candidates are rated/evaluated (702), e.g., on a G scale, based on the relevant historic and preference information, and the relevant information is stored (703) in a candidate database for subsequent access. The job candidate may be rated on a scale that accounts for a degree of placeability, e.g., based on experience, education, time at current company, frequency of job changes, and level at current job, and the degree of urgency in finding a new job.

Moreover, the candidate specialists may also be evaluated based on, e.g., the recruiter's evaluation, which may include experience, track record, and performance. For example, the candidate specialists may be ranked according to an amount of revenue derived from their services in placing job candidates, and/or how quickly they are able to place job candidates (e.g., average placement time in days). The specialists may be arranged into tiers such that specialists that generally perform at the same level are in the same tier.

Generally, the job candidate should be assigned to a selected candidate specialist according to a correspondence between the job candidate's evaluation and the selected specialist's evaluation. Job candidates with a G1 rating (the highest candidate rating), for example, may generally be assigned to a candidate specialist with greater experience and with a better track record for placement, whereas a candidate with a G5 rating (the lowest candidate rating) may be assigned to a candidate specialist with less experience and/or with a worse track record. The selected specialist is primarily responsible for placing the candidate in a job, although other candidate specialists, as well as client specialists, may also assist, as discussed further below in the “team oriented approach”.

Alternatively, candidates of a particular rating may be cyclically assigned to recruiters, such that every recruiter of a group of recruiters, may get the opportunity to place highly rated candidates.

Job candidates attracted by candidate specialists (705), e.g., through efforts made by the specialists, such as phone or personal contacts, should preferably be assigned to the specialist that attracted the job candidate. Similarly, a candidate specialist that selects unassigned job candidates (706), e.g., unassigned because of an expired assignment, as determined by searching the candidate database, preferably are assigned the job candidate they locate.

Irrespective of the method by which job candidates are assigned to candidate specialists, an expiration date for the assignment may be set (707). The expiration time may be a fixed time for all candidates, e.g., ninety days from the date of assignment, or may vary to conform to the complexity of the placement. For example, a longer expiration time may be set for placing job candidates with specialized skills, or a shorter expiration time may be set by request for job candidates or employers with time constraints. Between the start of the assignment and the expiration date, the candidate specialists attempt to match their job candidates to jobs openings (708). If a candidate specialist successfully places a job candidate prior to the expiration of the assignment (709), the candidate specialist may proceed to close the placement (710). If, however, a job candidate is not placed before the expiration date, the assignment ends, and the job candidate becomes unassigned. Unassigned candidates may then be assigned to a next candidate specialist, again preferably one with a corresponding evaluation, or be selected by a candidate specialist who searches the database of unassigned candidates.

The assignment of candidates to candidate specialists may be carried out in a computerized manner by providing a computer-generated interface for receiving and outputting information. For example, referring also to FIG. 5, one of the recruiter interfaces 504 may be operated by a recruiter or other personnel associated with the recruiting organization to store data regarding the evaluations of job candidates and recruiters, such as candidate specialists. A processor (e.g., at the server 507 and/or at the workstations) then executes software instructions to assign the job candidates to the recruiters based on a correspondence between their evaluations. For example, the software may match up more highly evaluated candidates with more highly evaluated recruiters, while also matching lower evaluated candidates with lower evaluated recruiters. The software may also account for the number of candidates that are currently assigned to a recruiter so that the assignments are spread among the recruiters relatively evenly or otherwise in proportion to the number of candidates that each recruiter can take on, or wishes to take on. Moreover, job candidates with the same rating may be assigned in a cyclical or round robin manner to the recruiters, such that each recruiter receives the next assignment, and after all recruiters receive one assignment, each receives a second assignment and so on until all candidates have been assigned.

The software may further be designed to access the database of information on a computer's storage medium (such as at the databases associated with the server 507) to assign a job candidate to another recruiter when the previously-selected recruiter is unable to place the candidate within a given time period. The job candidate may be assigned initially to the recruiter that obtained him or her. Furthermore, unassigned job candidates may be assigned to recruiters that select them via their computerized interfaces. For example, the recruiters may be able to view historical information and requirements and preferences criteria via the interface for the unassigned candidates, then select a candidate that he or she is interested in trying to place. The software responds to the recruiter's request by assigning the selected candidate to the recruiter, and updating the database so that other recruiters will know the candidate has been assigned.

Referring to FIG. 7b, a recruiting organization may include client specialists, who are responsible for obtaining employers with available jobs. Similar to the way job candidates are assigned to candidate specialists, the employers may be assigned to the client specialists. The process of assigning employers to client specialists for placement services may vary depending on the method by which the employers are attracted for recruiting services. For instance, employers attracted and screened by telemarketers (711) for follow-up client (employer) interviews, may be assigned to client specialists (714) based on the respective quality/evaluation of the employer and the specialist In such interviews, the client specialist discusses the employer's recruiting needs and obtains information on its available jobs. The matching of jobs with candidates (715) may then occur.

Moreover, preferably the employers are rated (712), such as on a T scale. In a specific example of the T scale, tier ratings maybe reviewed on quarterly or bi-quarterly intervals, or more often, on average every week, and if the situation warrants, in several daily updates with selected clients depending on the recent activities and news about the company or respective industry it operates in.

The following discussion of tiers is made from the perspective of the recruiting organization. Tier ratings reflect the status of the current active clients, e.g., (a) active, non-active, re-negotiate, re-develop, hiring freeze, contact freeze, don't touch, defunct; and b) client, ex-client, target, develop, and client rating, e.g., core, hot, proven, just signed, potential, unproven, desperate, slowing down, stalled, jobs filled, terminated.

TIER 1

Tier 1 clients are defined by two major points:

These companies are hiring aggressively, both in quantity and quickly. They need to build up their compares quickly to compete and bring m revenue.

The recruiting organization knows and understands these clients, both their business and their people.
1. These companies have been clients for some period of time, often several years.
2. Over that time, we have become acquainted not only with their Human Resources officers, but also with their line managers and executives.
3. We have already placed candidates into these client companies and have built up a high degree of trust, allowing us to negotiate effectively directly with the hiring managers and if necessary their HQ staff as well.
4. We understand their recruiting process, offer letters, stock options, incentives and company-specific bonuses.
5. We understand their organization (have the ability to produce a detailed organization chart) and how it relates and works with their headquarters, if overseas.
6. Often, we can introduce candidates without sending a resume in advance. Due to our close relationship and past success in placements, we can arrange meetings for candidates who we recommend.

Since Tier 1 clients are serious regarding recruiting and aggressively filling their hiring needs, the recruiting organization may offer the following services to assist our clients in achieving their goals:

Preferred client services. Assignment of an account manager to facilitate communication between the client and our consultants, as well as research for candidates.

Opportunity for the client to give a presentation to all our consultants to raise mind-share and knowledge of the particular client.

On-site recruiting. We will place a member of our Client Services on our client's site so that all recruiting responsibilities are channeled through this Account Manager for more effective recruiting.

Additional services may be offered depending on the clients' needs. We are able to organize and manage recruiting seminars, produce brochures and other marketing materials for our clients' recruiting purposes.

TIER 2

Tier 2 clients are strong clients, up-and-coming, great potential or otherwise compelling. The following details Tier 2 clients:

Hot to hire. Whereas Tier 1 clients are usually following a carefully coordinated and pre-arranged hiring plan, Tier 2 clients are desperate to hire. This could be the result of urgent needs to bring in more revenue or to support customers.

We understand to a certain extent how these companies work internally, and what their recruiting process is like. Of course, we have met with their management and understand their business; however we don't understand their company structure as deeply as we would hope; this can take weeks, and sometimes months to achieve—unfortunately, on average, most of the clients' hiring cycle is only about 6 months.

Usually still in a start-up mode (could be 10 staff in Japan or 500 staff in Japan—depending on the company and industry) and hiring for several key positions. They aren't usually hiring in quantity, but if we can help to place the key employees, we will open up more opportunities in the future.

TEIR 3

Tier 3 clients are core clients, and usually equal in terms of number of clients to Tier 4. The following traits describe Tier 3 clients:

We have made at least one placement into these clients. Usually we have dealt with these companies for some time and learnt their ways of doing business. We have some contacts in the HQ/APAC level and can consult directly with these people if necessary.

We have met the line managers but still may only have limited access to them—we usually know most of the key players in key positions.

These clients are hiring, but sometimes in a limited manner, maybe only one open job spec.

TIER 4

Tier 4 clients are companies in transition and new clients. Tier 4 clients are usually showing hiring potential, as they are either new clients who have just signed our fee agreement or non-active clients that have new headcount to fill. In addition, some Tier 4 clients will be slowing down their hiring. Tier 4 clients are characterized by the following traits:

We may have to introduce our candidates through the clients' Human Resources instead of directly contacting line managers. We may not have even met the executives yet.

We don't understand fully how their company works. We have been introduced to their business and products/services, but don't understand how their internal procedures work or how offers are generated.

The client may not have any approved budget for additional headcount.

TEIR 5

Tier 5 clients are non-active clients, or active but slow clients. These companies usually fall into one or more of the following categories:

Companies we have worked with in the past. We may or may not have placed candidates into these companies. However, they are currently not pro-actively hiring (all positions filled, stalled positions, no candidate meetings activity recently, no headcount from HQ and so on).

Companies that are potentially hiring in the near future, and show promise of being promoted to Tier 4.

Companies that are not doing well in their respective industry and therefore may soon be laying off employees.

Due to a change in management or recruiting policy, unsuccessful execution of their business, merger or for some other business reason, these companies no longer match our culture well and may be on its way to becoming a target for us, in other words, a source of candidates.

Thus, with the employer evaluation scheme above, the employers can be assigned to the client specialists that have corresponding evaluations, where the employer's evaluation may be based on factors such as its revenue-generating potential and/or previous revenue generating record, and the client specialist's evaluation may generally take into account, e.g., the specialists' experience, track record, and performance. The specialists may also be arranged in tiers such that those in a common tier have roughly equal performance. Employers with a T1 rating (the highest employer rating), for example, may be assigned to a specialist with greater experience and with a better track record for placement, whereas an employer with a T5 rating (the lowest employer rating) may be assigned to a specialist with less experience and/or with a worse track record. Employers attracted by specialists (713), e.g., through the specialists' efforts, should preferably be assigned to the specialist that attracted the employer. However, employers that are attracted by the same client specialist may still be assigned to other client specialists, for instance, if the given client specialist is too busy to handle them, or chooses to not handle them.

The assignment of the employers to the client specialists may be carried out in a computerized manner by providing a computer-generated interface for receiving and outputting information. For example, referring also to FIG. 5, one of the recruiter interfaces 504 may be operated by a recruiter or other personnel associated with the recruiting organization to store data regarding the evaluations of employers and recruiters, such as client specialists. The data may be stored locally or at a central location such as the server 507. A processor (at the server and/or workstation, depending on whether local or networked applications are used) then executes software instructions to assign the employers to the recruiters based on a correspondence between their evaluations. For example, the software may match up more highly evaluated employers with more highly evaluated recruiters, while also matching lower evaluated employers with lower evaluated recruiters. The software may also account for the number of employers that are currently assigned to a recruiter so that the assignments are spread among the recruiters relatively evenly or otherwise in proportion to the number of employers that each recruiter can take on, or wishes to take on. Moreover, employers with the same rating may be assigned in a cyclical or round robin manner to the recruiters, such that each recruiter receives the next assignment, and after all recruiters receive one assignment, each receives a second assignment, and so on, until all employers have been assigned.

The software may further be designed to access the database of information on the storage medium to assign an employer to another recruiter when the previously-selected recruiter is unable to fill the jobs (all the jobs or a predetermined portion of the jobs) of the employers within a given time period. The employer may be assigned initially to the recruiter that obtained it, e.g., through a referral, networking, personal contact, etc. The software may be designed to display the results on the interface in an appropriate manner, such as by providing a list of employer and recruiter matches.

IV. Obtaining Candidates and Job Openings for Employment Recruiting

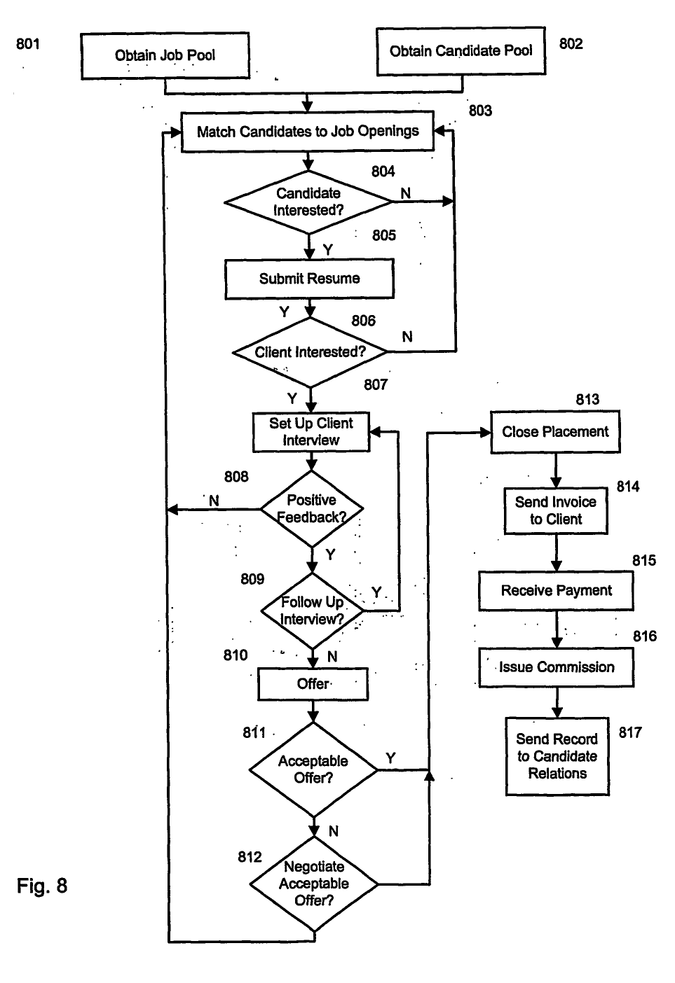

Referring to FIG. 8, a process for employment recruiting independently obtains a pool of job candidates and a pool of jobs. This is termed “reverse recruiting” since it does not follow the conventional idea of first obtaining a job opening, then finding a candidate to fill the opening. The conventional approach usually results in significant delays before an opening can be filled. With the present invention, a pool of candidates is always available so that jobs can be filled quickly. This is particularly advantageous for the IT industry and others where there is a strong demand for employees, and a lot of employee movement between companies.

Reverse recruiting may begin by obtaining a job opening pool (801) and obtaining a job candidate pool (802). The job candidate pool should be populated with placeable job candidates, for example, by populating (entering data into) a database of job candidates. The job candidates' placeability may be determined during initial screening teleconferences, as described above, which may be conducted by telemarketers or by recruiters, e.g., by phone, or during personal interviews conducted by the recruiters/candidate specialists. Similarly, the job opening pool may be populated with available jobs by signing employers with jobs for employment recruiting services. Preferably, the jobs are obtained by a client specialist or specialists, that is/are not candidate specialists. In this way, the disparate needs of the employers and the candidates can be handled by respective dedicated personnel at the recruiting organization.

Next, candidates may be matched with jobs (803), which generally denotes pairing job candidates with available jobs, taking into account the requirements and preferences criteria, discussed previously, provided by both the job candidates and the employers. The match may be accomplished by the candidate specialists searching the job-opening database for available positions that coincide with the criteria provided by job candidates assigned to them. Alternatively, or in addition, the match may be accomplished by the client specialists searching the job candidate database for job candidates that coincide with the employer criteria provided. In one possibility, the candidate specialists and client specialists match candidates with jobs in a cooperative effort. The cooperative effort maybe between candidate specialists, such as by having those with knowledge of available jobs offering relevant job opening information to other candidate specialists, or candidate specialists communicating their respective knowledge of job candidates and available jobs to one another in a group. Thus, the candidate specialist to whom a candidate is assigned may be assisted by other candidate specialists.

Likewise, the cooperative effort may be between client specialists such as those with knowledge of available jobs offering relevant job opening information to other client specialists, or client specialists communicating their respective knowledge of job candidates and available jobs to one another in a group. Further, the cooperative effort may be between candidate specialists and client specialists who communicate their respective knowledge of jobs and job candidates to one another.

When at least one match has been made, the job opening is presented to the job candidate to determine whether the individual is interested (804). Preferably, the job candidate is presented with three matching jobs for review. If the job candidate is not interested in the jobs presented, the individual may be processed for a next match or set of matches. It however, the job candidate is interested in any or all of the matching jobs, the job candidate's resume may be sent (805) to the associated employer(s) for review. Optionally, based on an employer's request, a client specialist will review the job candidate's resume for conformance with the employer's criteria prior to trasmittal of the resume. If the employer is interested (806) in the job candidate, an interview may be arranged between the employer and the job candidate (807). This interview may follow the ICI. After the interview, communications with the employer may be established for feedback on the success of the client-employer interview (808). If there is negative feedback, i.e., the employer is not interested in the job candidate, the job candidate may be referred for further matching. It, however, there is positive feedback, i.e., the employer shows interest in the job candidate, a follow up interview with the employer may be arranged (809).

Preferably, the job candidate receives a job offer (810) as a result of the matching efforts. If the offer is not acceptable, it may be negotiated by the candidate specialist assigned to the job candidate and/or by a client specialist that is assigned to the employer. Optionally, the terms of the offer may be negotiated before a formal offer is presented. If the offer is acceptable to the job candidate as presented (811) or after negotiation (812), the match may proceed to closing (813), which generally denotes finalizing the job placement, including communicating acceptance to the offer, signing relevant documents, and receiving payment for the services. Optionally, payment for services may occur at an agreed time, such as after the job candidate completes a probationary period, at which time the client/employer is sent an invoice for the services rendered (814). This hopefully results in receiving payment from the client (815). Note, the employer has been referred to as the client with respect to the party paying the fee for recruiting services, however, in appropriate circumstances, the fee may be charged to other parties, such as the job candidate. That is, in some cases, the candidate will pay a fee for the recruiting services, while in other cases the services are employer-paid. In another alternative, the fee is paid by a sponsoring party such as a charity or government agency.

After the placement, the commissions due the respective individuals that contributed to the placement, such as candidate specialists and client specialists, may be issued (816), as discussed previously in connection with FIG. 6. Optionally, a record of the job candidate containing information relevant to the placement, such as the candidate's name, the matching employers, salary, contact information, preference information, ratings, etc., may be stored in a candidate relations database for future reference (817).

The managing of the job candidates, employers and job openings may be carried out in a computerized manner by providing a computer-generated interface for receiving and outputting information. For example, referring also to FIG. 5, one of the recruiter interfaces 504 may be operated by a recruiter or other personnel associated with the recruiting organization to store data identifying the pool of job candidates and pool of available jobs from the associated employers. In one possibility, the recruiter interfaces include separate interfaces used by the candidate specialists and the client specialists, where a candidate specialist (or other associated operator) uses one interface to enter the data identifying the pool of available candidates, and a client specialist (or other associated operator) uses another interface to enter the data identifying the pool of available jobs. The data may be stored at a centralized location, such as the databases 508, 510, 520, via communications by the network 512. Note that the telemarketer's interface 501 may also enter data to these databases in place of, or in addition to, the data entered via the interfaces of the client specialists and candidate specialists. The data stored may also include the criteria provided by the candidates and the employers, as discussed previously.

The assigning of the employers/job openings to the client specialists may also be carried out in a computerized manner. For example, a processor in a computer (e.g., the server 507 and/or local workstation) may execute software instructions to assign the employers to the client specialists based on a correspondence between their evaluations such that more highly evaluated employers are assigned to more highly evaluated client specialists. The software may also account for the number of employers that are currently assigned to a specialist so that the assignments are spread among the specialists relatively evenly or otherwise in proportion to the number of employers that each specialist can take on, or wishes to take on. The software may offer be designed to access the database of information on the computer's storage medium to assign an employer to another client specialist when the previously-selected specialist is unable to fill all or a predetermined portion of the jobs of the employers within a given time period. The employer maybe assigned initially to the specialist that obtained it, e.g., through a referral, networking, personal contact, etc.

Additionally, a processor in a computer (e.g., the server 507 and/or local workstation) may execute software instructions to assign the available job candidates to the candidate specialists based on a correspondence between their evaluations such that more highly evaluated candidates are assigned to more highly evaluated candidate specialists. The software may also account for the number of candidates that are currently assigned to a specialist so that the assignments are spread among the specialists relatively evenly or otherwise in proportion to the number of candidates that each specialist can take on, or wishes to take on. The software may further be designed to access the databases of information on the computer's storage medium to assign a candidate to another candidate specialist when the previously-selected specialist is unable to place the candidate within a given time period. The candidate may be assigned initially to the specialist that obtained him or her, e.g., through a referral, networking, personal contact, etc. The software may be designed to display the results on the interface in an appropriate manner, such as by providing a list of candidates, job matches, candidate specialist matches, and client specialist matches.

V. Team Oriented Approach to Matching Candidates with Jobs

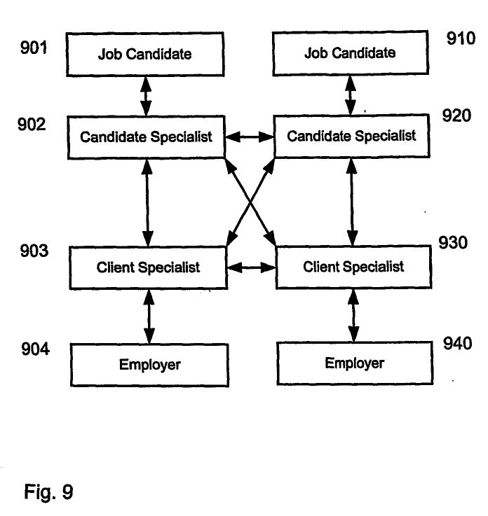

Referring to FIG. 9, job candidates may be matched to jobs in a cooperative effort. For example, example job candidates (901) and (910) are each assigned to candidate specialists (902) and (920), respectively. Employers with jobs (904) and (940) are assigned to client specialists (903) and (930), respectively. The cooperative effort may include open communications between candidate specialists, such as candidate specialists (902) and (920), to match their respective job candidates withjobs. For instance, candidate specialist (902) with knowledge of available jobs and of job candidate (910) may openly communicate relevant job information to candidate specialist (920). Candidate specialist (920) may do the same for candidate specialist (902) by providing information on jobs that may be suitable for the candidate (901). A group of candidate specialists with knowledge of job candidates and of available jobs may also communicate with each other information relevant to one another's assigned job candidates or other job candidates in a group.

Similarly, the cooperative effort may include open communications between client specialists, such as specialists (903) and (930), to match their respective employers with job candidates. For instance, specialist (903) with knowledge of available job candidates and of employer (904) may openly communicate job candidate information relevant to employer (904) to specialist (930). Client specialist (930) may do the same for specialist (903) by communicating job candidate information relevant to employer (940) to specialist (903).

Moreover, a group of client specialists with knowledge of job candidates and of available jobs may also communicate with each other information relevant to one another's assigned employers or other employers in a group. The cooperative effort, further, may include open communications between candidate specialists and client specialists, or a combination of a plurality thereof.

The team-oriented method of matching candidates with jobs may be carried out in a computerized manner by providing a computer-generated interface for receiving and outputting information. For example, referring also to FIG. 5, the recruiter interfaces 504 may include interfaces that are operated by client specialists and candidate specialists or other personnel associated with the recruiting organization to store data regarding the pool of job candidates and the pool of available jobs from the associated employers. The data may be stored at a centralized location, such as the databases 508, 510, 520, via communications by the network 512.

A processor associated with a central and/or local computer is adapted to access the storage medium (e.g., databases) and execute software instructions to match the job candidates to the jobs by a cooperative effort between the candidate specialists, the client specialists, and/or the candidate specialists and the client specialists. In one approach, a candidate specialist suggests potential candidate-job matches to another candidate specialist. In another approach, a client specialist suggests potential candidate-job matches to another client specialist. In a further approach, a combination of the above processes is used (e.g., client specialist to candidate specialist, and candidate specialist to client specialist communications).

In particular, the interfaces may be configured to allow the specialists to communicate with one another to suggest potential candidate-job matches. For example, a database index or other identifier may be referenced to specifically identify a candidate and/or job (ex: candidate C22, job J102). In another approach, a message can be sent between specialists that causes information regarding a potential candidate-job match to be displayed, e.g., in the form of a resume of the candidate and a description of the job, along with evaluations of the candidate and/or employer, and other information such as the commission which may be earned from the placement, the time period in which the candidate has been looking for a job, and the time period in which the job has been available. The information may be displayed in detailed or summary, form. When in summary form, a hyperlink or other link to further detailed information may be provided. When the link is activated, the database is accessed to obtain and display the associated information on the specialist's interface, e.g., in a new screen or pop up screen. The communications between the specialists interfaces may be via e-mail, instant messaging, or any other available system.

VI. Matching Candidates with Jobs Incorporating Job Candidate and Employer Evaluations

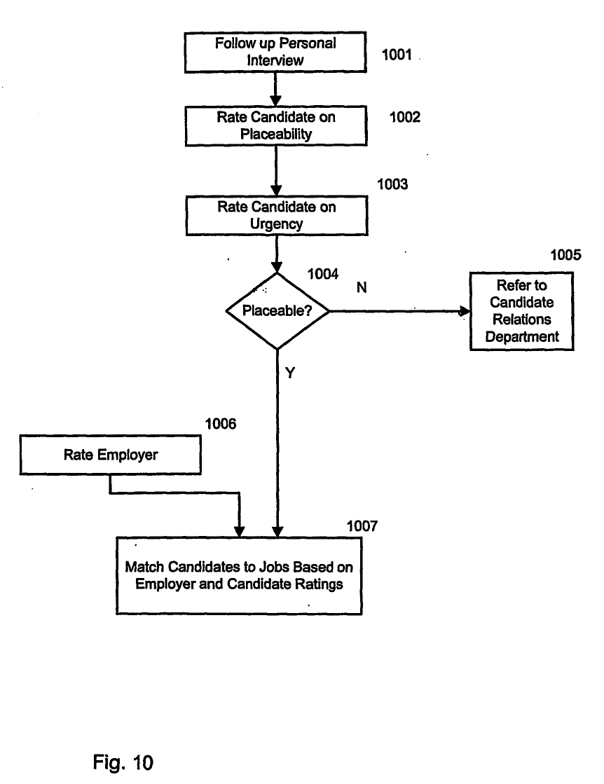

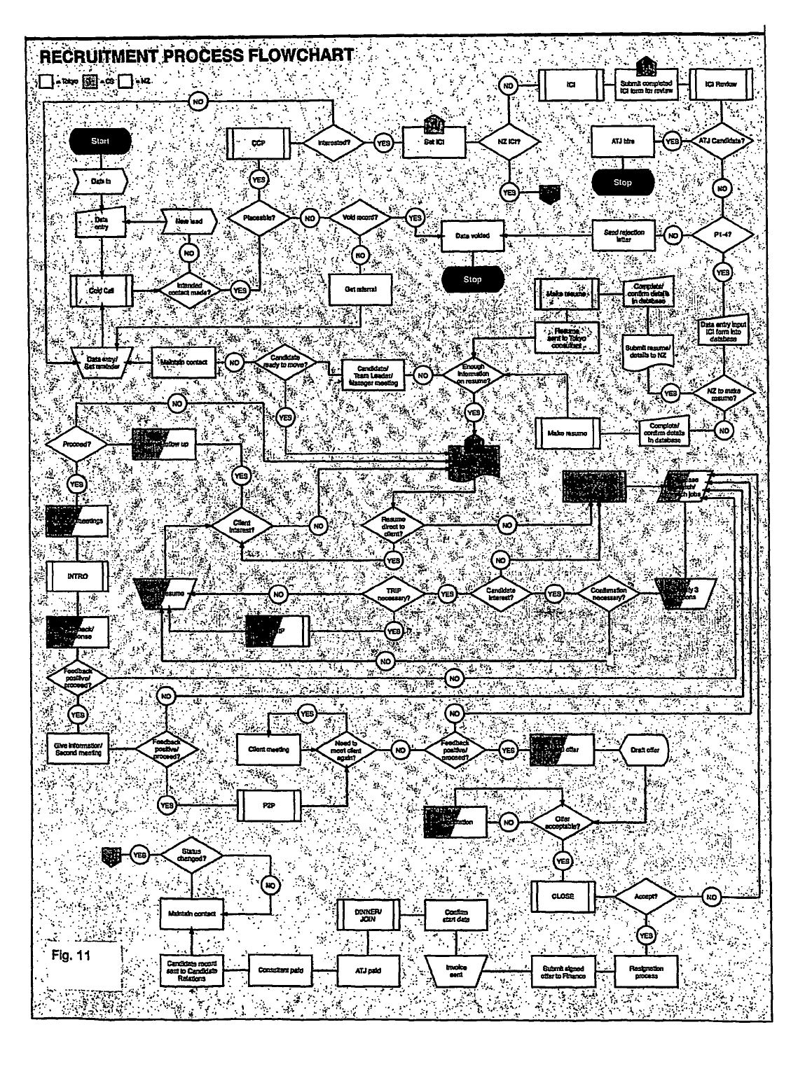

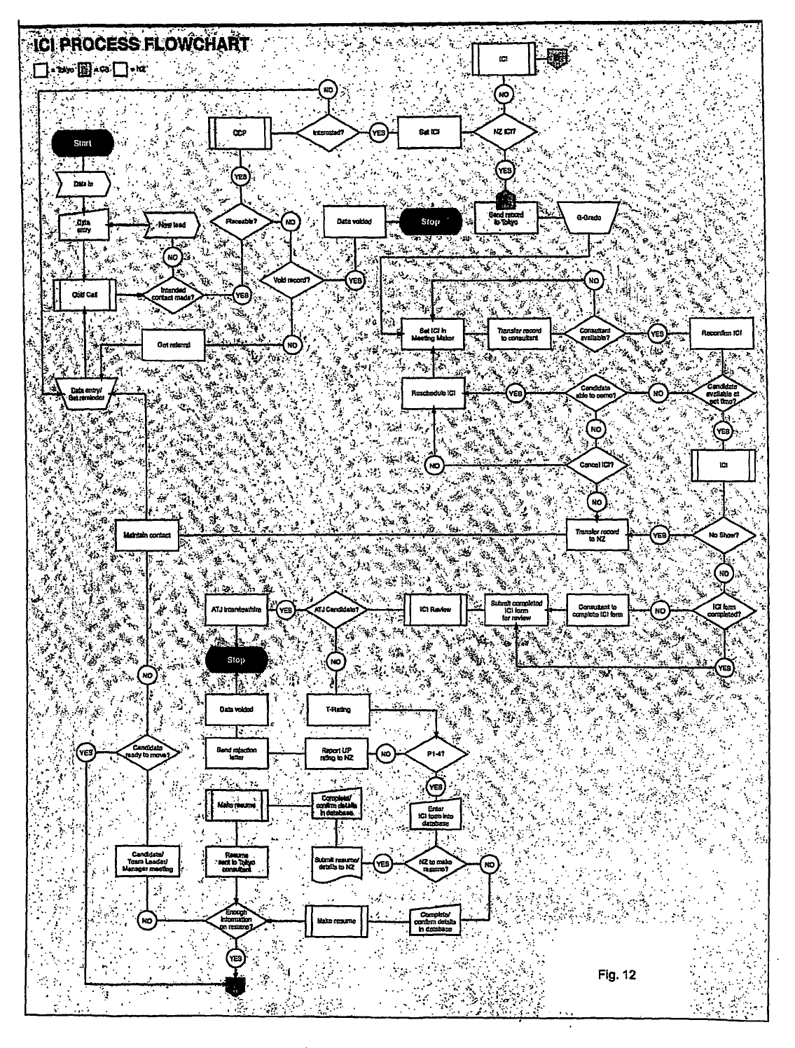

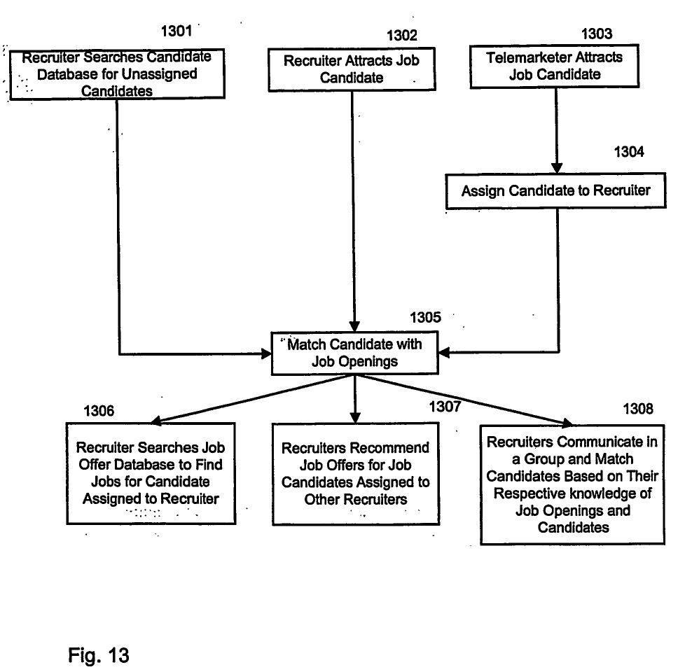

Referring to FIG. 10, a process is shown for matching job candidates with available jobs based on job candidate and employer ratings. The process may begin with a follow-up personal interview (1001), i.e., the ICI, which is used to confirm information obtained during initial screening teleconferences, obtain additional relevant information, and further evaluate the quality of the job candidates regarding interpersonal skills, appearance, speech, and attitude. For example, the candidate may be evaluated initially by an administrative employee of the recruiting firm, such as a receptionist who makes an initial contact with the candidate, and then by a candidate specialist based on a formal interview.

The candidate specialist that conducts the follow-up personal interview should confirm the historic information and criteria that may have been obtained during the initial screening teleconference and supplement the information with relevant additional or new information. The candidate specialist may further evaluate the quality of the job candidate abased on first impression, interview skills, and so forth, incorporating comments prepared by the administrate employee, and may also inquire into the candidate's willingness to change positions, and the salary and position sought.

The candidate specialist may then evaluate candidates on their relative placeability (1002) and on urgency for placement (1003). Placeability may be in the form of a P scale, e.g., including P1 to P4, and UP (unplaceable) designations, where P1 indicates the highest placeability, P2 the next highest, and so forth. The P rating may encompass at least some of the relevant elements considered for placeability, such as the candidate's education, experience, time at current company, frequency of job changes, level at current or previous job, etc., and additional information gathered during the follow-up personal interview, such as the candidate's first impression, interview skills, etc., and the comments prepared by the administrative personnel. An example P rating scheme is as follows:

P1

Job type: Sales and Engineers only

5-7 min. years experience in the IT industry

Intermediate English minimum requirement

Preferably less than 10 years at one company

P2

Job type: Sales and Engineers only

Min. 5 years in IT industry

Max. 12 years at one company

English: Functional+

Foreigners:
Foreign bank IT engineer No Japanese is ok
Non bank Engineer-Advanced Japanese is required.

P3

Job type: All

Min 2 years in IT

Max 15 years in one company

English for sales/engineers: Functional+

Advanced English for the rest

P4

Borderline candidates

2 years in IT.

UP

No English skills for Japanese nationals/No Japanese for foreigners.

No IT related skills

Poor personality/motivation

Additionally, urgency may be in the form of a U scale comprising the set of A, B, or C designations, where an A urgency is deemed a greater urgency than a B urgency and a B higher than a C. The U rating may include the candidate's willingness to change positions, and/or the salary and positions sought in relation to the candidates qualifications. Candidates with a C rating are typically unwilling or unable to accept a position. Similarly, candidates demanding an unrealistic salary or a position not commensurate with their qualifications may be classified as low urgency C candidates.

The candidate specialist should reassess the candidate's placeability (1004) based on the information gathered during the follow-up personal interview. If the candidate is not placeable, i.e., a UP and/or a C candidate, the candidate's records may be sent to the candidate relations department for future attention (1005).

A method of matching job candidates with available jobs while incorporating job candidate and employer evaluations may include rating the quality of employers and their respective jobs (1006). The quality of an employer may be derived, e.g., from its revenue-generating potential. Preferably, employers are rated, such as on a T scale comprising the set of T1 to T5 designations, where a lower numerical T rating indicates a higher grade. For example, a T1 is greater than T2, etc. The T rating comprises factors indicative of the revenue generating potential for the recruiting company, such as the quantity of jobs listed with the company, etc.

Candidate specialists may then proceed to match job candidates with available jobs using the job candidate and employer ratings (1007), e.g., by searching the job opening database for available jobs that coincide with the preference information provided by the job candidates. The database search may be a keyword search, such as by position, salary, education sought, rating, and so forth. Alternatively, the match may be performed by the client specialists searching the job candidate database for available candidates whose criteria coincide with the criteria provided by the employers, or in a cooperative effort as provided above.

The matching of candidates with jobs using ratings may be carried out in a computerized manner by providing a computer-generated interface for receiving and outputting information. For example, referring also to FIG. 5, the recruiter interfaces 504 may be operated by client specialists, candidate specialists or other personnel associated with the recruiting organization to store data obtained by evaluating the job candidates and the employers. The data may be stored at a centralized location, such as the databases 508,510, 520, via communications by the network 512. A processor associated with a central and/or local computer is adapted to access the storage medium (e.g., databases) and execute software instructions to match the job candidates to the jobs according to a correspondence between the job candidate's evaluating and the employer's evaluating. Thus, more highly rated candidates are matched to more highly rated jobs.

In another approach, the recruiter interfaces 504 are operated to store data obtained by rating the job candidates and employers, where the job candidates are rated on a scale that accounts for a degree of placeability, and/or a scale that accounts for a degree of urgency in finding a new job, and the employers with respective available jobs are rated by accounting for the amount of jobs associated with the particular employer out of a total number of jobs of the pool of available jobs for a predetermined time period. Thus, a given employer that has relatively many jobs to fill is rated relatively higher. A processor associated with a central and/or local computer is adapted to access the storage medium (e.g., databases) and execute software instructions to assign job candidates to recruiters, and to match the job candidates to the available jobs according to a correspondence between the job candidate's rating and the employer's rating. The software may be designed to display the results on the interface in an appropriate manner, such as by providing a list of candidates, job matches, and recruiter matches.

Accordingly, it can be seen that the present invention provides methods and systems for employment recruiting. In one aspect, a remote call center is used to make initial contact with the candidates to obtain information regarding their placeability and urgency in changing jobs, and to provide an initial screening. With this approach, candidates deal personally with someone who is part of the local community, while the call center can be located in a low cost area. A local candidate specialist may then personally interview the candidate.

In another aspect, compensation is set for recruiters by adjusting a base compensation based on individual and group performance. The compensation structure enhances communication and sharing of information that could assist in placing candidates in jobs.

In another aspect, candidates are assigned to candidate specialists, and client employers are assigned to client specialists.

In another aspect, job candidates and job openings are independently obtained so that candidates will be available immediately to fill the openings. Moreover, candidate specialists may primarily provide services to the candidates, while client specialists primarily provide services to the employers.

In another aspect, in a team-oriented method of matching candidates with jobs, candidates may be matched to jobs by cooperation among candidate specialists and client specialists

In another aspect, candidates are matched with jobs using candidate and employer ratings.

The invention has been described in an illustrative manner, and it is to be understood that the terminology that has been used is intended to be in the nature of words of description rather than of limitation. The invention may be embodied in other specific forms without departing from the spirit or essential characteristics thereof. The present embodiments are therefore to be considered in all respects as illustrative and not restrictive.

What is claimed is:

1. A system for matching job candidates to jobs, comprising:
a computer readable medium for storing: (a) candidate information, including names of job candidates, historical information, a potential candidate's interest in leaving a current job, and at least one of requirements and preference criteria of a potential candidate, and (b) job information; wherein:
an employment recruiter is assigned to a candidate whose name is stored based at least partially on evaluation information stored for that candidate;
the candidate information and job information is accessed from the computer readable medium or mediums with the aid of a computer to determine potential matches; and
an employment recruiter selects a job for consideration by a potential candidate to whom the recruiter has been assigned.

2. A telecommunications system for use by an employment recruiting organization, comprising:
a first telecommunications apparatus at a first facility at a location that is local with respect to a job market;
wherein the first telecommunications apparatus is operatively coupled to a telephone communications system providing at least one telephone number either local with respect to the location of a job market or toll-free, and the first facility has a staff including employment recruiters;
a second telecommunications apparatus at a second facility at a location that is remote with respect to the job market;
wherein the second telecommunications apparatus is operatively coupled to the telephone communications system, and the second facility has a staff including telemarketers;
wherein the first and second telecommunications apparatuses employ a call forwarding feature of the telephone communications system to forward calls to the at least one telephone number of the first facility to the second facility for answering by a telemarketer at the second facility.

3. A telecommunications facility for use by an employment recruiting organization, comprising:
a first telecommunications apparatus at a first facility at a location that is local with respect to a job market;
wherein the first telecommunications apparatus is operatively coupled to a telephone communications system providing at least one telephone number either local with respect to the location of a job market or toll-free, and the first facility has a staff including employment recruiters;
a second telecommunications apparatus at a second facility at a location that is remote with respect to the job market;
wherein the second telecommunications apparatus is operatively coupled to the telephone communications system, and the second facility has a staff including telemarketers;
wherein the first and second telecommunications apparatuses employ a call identification feature of the telephone communications system which indicates to a potential job candidate called by a telemarketer at the second facility the at least one telephone number of the first facility.

4. A system for use by an employment recruiting organization in setting compensation for each employment recruiter of a group of employment recruiters providing employment services, comprising:
a storage medium for storing: (a) data that indicates a base compensation and a performance goal for a particular function or set of functions for each recruiter in the group of recruiters, (b) data that indicates an actual performance of a particular recruiter, and (c) data that indicates an actual performance of the group; and
a processor adapted to access the storage medium and execute instructions to determine an actual compensation for the particular recruiter according to the base compensation of the particular recruiter, the actual performance of the particular recruiter, and the actual performance of the group.

5. The system of claim 4, further comprising:
at least one user computer-implemented interface for receiving an operator input for storing data in the storage medium, and for presenting the actual compensation.

6. The system of claim 4, wherein:
the actual performance of the particular recruiter and the actual performance of the group are measured over a predetermined time period.

7. The system of claim 4, wherein:
the actual performance of the particular recruiter is measured based on a revenue derived from the particular recruiter, and the actual performance of the group is measured based on a revenue derived from the group.

8. The system of claim 4, wherein:
the actual performance of the particular recruiter is measured based on a number of job candidates placed in jobs by the particular recruiter, and the performance of the group is measured based on a number of job candidates placed in jobs by the group.

9. The system of claim 4, wherein:
the actual compensation is determined by adjusting the base compensation according to the actual performance of the group to obtain a group-adjusted compensation, and adjusting the group-adjusted compensation according to the actual performance of the particular recruiter.

10. The system of claim 4, wherein:
the actual compensation is determined by adjusting the base compensation according to the actual performance of the particular recruiter to obtain an individual-adjusted compensation, and adjusting the individual-adjusted compensation according to the actual performance of the group.

11. The system of claim 4, wherein:
the actual compensation is determined by adjusting the base compensation according to the actual performance of the particular recruiter, and adjusting the base compensation according to the actual performance of the group.

12. The system of claim 4, wherein:
an actual performance of each respective recruiter in the group is measured; and
an actual compensation for each respective recruiter is determined according to the base compensation thereof, an actual performance thereof, and the actual performance of the group.

13. The system of claim 4, wherein:
the actual performance of the particular recruiter is measured based on how quickly job candidates are placed in jobs by particular recruiters.

14. The system of claim 4, wherein:
the actual performance of the particular recruiter is measured based on compensation of jobs in which job candidates are placed by the particular recruiter.

15. The system of claim 4, wherein:
the actual performance of the particular recruiter is measured based on a evaluation of employers at which the job candidates are placed by the particular recruiter, such that actual performance of the particular recruiter is determined to be higher when a candidate is placed at a higher evaluation employer.

16. A system of setting compensation for each individual, of a group, performing a service resulting from the contribution or contributions of one or more individuals in the group, comprising:
a storage medium for storing: (a) data that indicates a base compensation and a performance goal for a particular function or set of functions for each individual in the group; (b) data that indicates a performance goal for the group; (c) data that indicates an actual performance of the particular individual; and (d) data that indicates an actual performance of the group; and
a processor adapted to access the storage medium and execute instructions to determine an actual compensation for the particular individual according to the base compensation of the particular individual, an actual performance of the particular individual, and an actual performance of the group.

17. The system of claim 16, wherein:
the actual performance of the, particular individual and the actual performance of the group are measured over a predetermined time period.

18. The system of claim 16, wherein:
the actual performance of the particular individual is measured based on a revenue derived from the particular individual's contribution to the services, and the actual performance of the group is measured based on a revenue derived from the group's services.

19. The system of claim 16, wherein:
the actual compensation is determined by adjusting the base compensation according to an actual performance of the group to obtain a group-adjusted compensation, and adjusting the group-adjusted compensation according to the actual performance of the individual.

20. The system of claim 16, wherein:
the actual compensation is determined by adjusting the base compensation according to an actual performance of the particular individual to obtain an individual-adjusted compensation, and adjusting the individual-adjusted compensation according to the actual performance of the group.

21. The system of claim 16, wherein:
the actual compensation is determined by adjusting the base compensation according to an actual performance of the particular individual and adjusting the base compensation according to the actual performance of the group.

22. The system of claim 16, wherein:
the service performed by the individuals comprise employment recruiting, and the actual performance of the particular individual is measured based on how quickly job candidates are placed in jobs by the particular individual.

23. The system of claim 16, wherein:
the service performed by the individuals comprise employment recruiting, and the actual performance of the particular individual is measured based on compensation of jobs in which job candidates are placed by the particular individual.

24. The system of claim 16, wherein:
the service performed by the individuals comprise employment recruiting, and the actual performance of the particular individual is measured based on a evaluation of employers at which the job candidates are placed by the particular individual, such that actual performance of the particular individual is determined to be higher when a candidate is placed at a higher evaluation employer.

25. The system of claim 16, wherein:
the group of individuals comprise a plurality of candidate specialists and a plurality of client specialist, each performing a divisible portion of employment recruiting.

26. The system of claim 25, wherein:
the divisible portion of employment recruiting comprises obtaining job candidates for employment recruiting;
the actual performance of a particular candidate specialist is measured based on a number of job candidates placed in jobs by the particular candidate specialist; and
the performance of the group is measured based on a number of job andidates placed in jobs by the group.

27. The system of claim 25, wherein:
the divisible portion of employment recruiting comprises obtaining jobs for employment recruiting;
the actual performance of a particular client specialist is measured based on a number of job candidates placed in jobs by the particular client specialist; and
the performance of the group is measured based on a number of job candidates placed in jobs by the group.

28. A system for assigning job candidates to recruiters in a group of recruiters, comprising:
a storage medium for storing data indicative of evaluations of the job candidates, and data indicative of evaluations of the recruiters in the group; and
a processor, adapted to access the storage medium, for executing instructions to assign the job candidates to a respective selected one of the recruiters according to a correspondence between the job candidate's evaluation and the selected recruiter's evaluation.

29. The system of claim 28, wherein:
the job candidates are evaluated on a scale that accounts for a degree of placeability.

30. The system of claim 29, wherein:
the placeability accounts for at least one of: experience, education, time at current company, frequency of job changes, and level at current job.

31. The system of claim 29, wherein:
the job candidates are evaluated on a scale that accounts for a degree of urgency in finding a new job.

32. The system of claim 28, wherein:
the recruiters are evaluated according to their track records in placing job candidates.

33. The system of claim 32, wherein:
the recruiters are evaluated according to an amount of revenue derived from their services in placing job candidates.

34. The system of claim 32, wherein:
the recruiters are evaluated according to how quickly they are able to place job candidates.

35. The system of claim 28, wherein:
the job candidates are assignee to a respective one of the recruiters according to a correspondence between the job candidate evaluation and the recruiter evaluation, such that more highly evaluated job candidates are assigned to more highly evaluated recruiters.

36. The system of claim 28, wherein:
the job candidates are assigned to a respective one of the recruiters according to a correspondence between the job candidate evaluation and the recruiter evaluation, such that job candidates with the same evaluation are cyclically assigned to recruiters.

37. The system of claim 28, wherein:
the processor is adapted to access the storage medium and execute instructions to assign the job candidates to another selected one of the recruiters when the recruiter previously selected therefor is unable to place the job candidates within a give time period.

38. The system of claim 28, wherein:
the processor is adapted to access the storage medium and execute instructions to assign the job candidate to the recruiter that obtained the job candidate, and assign the job candidate to another selected one of the recruiters when the recruiter previously selected therefor is unable to place the job candidate within a give time period.

39. The system of claim 28, wherein:
the processor is adapted to access the storage medium and execute instructions to assign job candidates whose previous assignment expired to the recruiter that selects the unassigned job candidates from a group of job candidates.

40. The system of claim 39, wherein:
the processor is adapted to access the storage medium and execute instructions to assign the job candidates to another selected one of the recruiters when the recruiter that previously selected the job candidate is unable to place the job candidate within a give time period.

41. A system for use in employment recruiting, comprising:
a storage medium for storing data identifying a pool of job candidates, and data identifying a pool of available jobs from associated employers;
wherein the pool of available jobs from associated employers is obtained independently of the obtaining of the pool of job candidates.

42. The system of claim 41, further comprising:
at least a first computer-implemented user interface for receiving an operator input for storing the data identifying the pool of job candidates in the storage medium; and
at least a second computer-implemented user interface for receiving an operator input for storing the data identifying the pool of available jobs in the storage medium.

43. The system of claim 42, wherein:
the interfaces communicate with the storage medium via at least one network; and at least one of the interfaces is remote from the storage medium.

44. The system of claim 42, wherein:
the operator associated with the first user interface is a candidate specialist or telemarketer.

45. The system of claim 42, wherein:
the operator associated with the second user interface is a client specialist or telemarketer.

46. The system of claim 41, wherein the storage medium stores data indicative of predetermined criteria provided by the job candidates and the employers; further comprising:
a processor, adapted to access the storage medium, for executing instructions to match the job candidates with the available jobs in accordance with the criteria

47. The system of claim 46, wherein:
the criteria provided by the job candidates includes at least one of: a desired position, salary, location, and urgency for a new position.

48. The system of claim 46, wherein:
the criteria provided by the employers includes at least one of: a desired education, experience, time at current company, frequency of job changes, and level at the job candidate's current or previous job.

49. The system of claim 41, wherein:
the storage medium stores data indicating evaluations of the employers and of respective client specialists in a group of client specialists;
the processor is adapted to access the storage medium and execute instructions to assign the available jobs of each of the employers to respective ones of the client specialists according to a correspondence between their evaluations such that more highly evaluated employers are assigned to more highly evaluated client specialists.

50. The system of claim 49, wherein:
the client specialists are evaluated according to their track records in filling available jobs.

51. The system of claim 49, wherein:
the client specialist are evaluated according to an amount of revenue derived from their services in filling available jobs.

52. The system of claim 49, wherein:
the client specialists are evaluated according to how quickly they are able to fill available jobs.

53. The system of claim 49, wherein:
the respective employers are evaluated according to an amount of fees they pay to fill their respective available jobs.

54. The system of claim 49, wherein:
the processor is adapted to access the storage medium and execute instructions to assign the available jobs of at least a selected one of the employers to another selected one of the client specialists when the client specialist previously selected therefor is unable to fill the available jobs of the selected employer within a given time period.

55. The system of claim 41, wherein:
the storage medium stores data indicating evaluations of the job candidates and of respective candidate specialists in a group of candid specialists and
the processor is adapted to access the storage medium and execute instructions to assign the available job candidates to respective selected candidate specialists according to a correspondence between their respective evaluations, such that more highly evaluated job candidates are assigned to more highly evaluated candidate specialists.

56. The system of claim 55, wherein:
the candidate specialists are evaluated according to their track records in filling available jobs.

57. The system of claim 55, wherein:
the candidate specialists are evaluated according to an amount of revenue derived from their services in filling available jobs.

58. The system of claim 55, wherein:
the candidate specialists are evaluated according to how quickly they are able to fill available jobs.

59. The system of claim 55, wherein:
the respective employers are evaluated according to an amount of fees they pay to fill their respective available jobs.

60. The system of claim 55, wherein:
the processor is adapted to access the storage medium and execute instructions to assign the available job candidates to another selected one of the candidate specialists when the candidate specialist previously selected therefor is unable to place the candidate within a given time period.

61. A system for matching job candidates with available jobs, comprising:
the storage medium for storing data regarding a pool of job candidates and a pool of available jobs from associated employers,
respective computer-implemented interfaces for use by respective candidate specialists to which the job candidates are assigned, and respective client specialists to which the employers are assigned; and
a processor, adapted to access the storage medium, for executing instructions for use in matching at least a particular one of the job candidates in a pool of job candidates to at least a particular one of available jobs in a pool of available jobs from associated employers in a cooperative effort between at least one of: (a) the candidate specialists, (b) the client specialists, and (c) the candidate specialists and the client specialists.

62. The system of claim 61, wherein:
for the cooperative effort between candidate specialists, a candidate specialist suggests to another candidate specialist to which a particular job candidate is assigned, via their respective interfaces, particular ones of the available jobs which are believed to be suitable for the particular job candidate.

63. The system of claim 61, wherein:
for the cooperative effort between client specialists, a client specialist suggests to another client specialist to which a particular employer is assigned, via their respective interfaces, particular ones of the available job candidates which are believed to be suitable for the respective available jobs of the particular employer.

64. The system of claim 61, wherein:
for the cooperative effort between the candidate specialists and the client specialists, a client specialist suggests to a candidate specialist to which a particular job candidate is assigned, via their respective interfaces, particular ones of the available jobs which are believed to be suitable for the particular job candidate, and a candidate specialist suggests to a client specialist to which a particular employer is assigned, via their respective interfaces, particular ones of the available job candidates which are believed to be suitable for the respective available jobs of the particular employer.

65. A system for matching job candidates with available jobs, comprising:
a storage medium for storing data obtained by evaluation the job candidate, and by evaluation employers with respective available jobs; and
a processor adapted to access the storage medium and execute instructions to match to the job candidates to the available jobs according to a correspondence between the job candidate's evaluation and the employer's evaluation.

66. The system of claim 65, wherein:
the job candidates are evaluated on a scale that accounts for a degree of placeability.

67. The system of claim 66, wherein placeability accounts for at least one of:
experience, education, time at current company, frequency of job changes, and level at current job.

68. The system of claim 65, wherein:
the job candidates are evaluated on a scale that accounts for a degree of urgency in finding a new job.

69. The system of claim 65, wherein:
the employers are evaluated on a scale that accounts for the amount of jobs associated with the particular employer out of a total number of jobs of the pool of available jobs.

70. The system of claim 65, wherein:
the employers are evaluated on a scale that accounts for the amount of jobs associated with the particular employer out of a total number of jobs of the pool of available jobs for a predetermined time period.

71. The system of claim 65, wherein:
each of the employers is evaluated on a scale that accounts for the amount of revenue provided thereby in a predetermined time period.

72. A system of matching job candidates in a pool of job candidates with available jobs in a pool of available jobs, comprising:
a storage medium for storing data obtained by: (a) evaluation the job candidate at least on one of: (a1) a scale that accounts for a degree of placeability, and (a2) a scale that accounts for a degree of urgency in finding a new job, and (b) evaluation employers with respective available jobs by accounting for the amount of jobs associated with the particular employer out of a total number of jobs of the pool of available jobs for a predetermined time period;
a processor adapted to access the storage medium and execute instructions to assign at least a particular job candidate of the pool of job candidates to a particular recruiter in a group of recruiters, and to match the job candidates to the available jobs according to a correspondence between the job candidate's evaluation and the employer's evaluation.
